(19) United States
(12) Patent Application Publication
(10) Pub. No.: US 2017/0205878 A1
(43) Pub. Date: Jul. 20, 2017

(54) Systems and methods for implementing a user-actuated controller device for use with a standard computer operating system having a plurality of pre-existing applications

(71) Applicant: Tandem Interface Pty Ltd, Sydney, New South Wales (AU)

(72) Inventors: Michael J.D. Hoste, Sydney (AU); Patricia Shelley Hoste, Sydney (AU)

(21) Appl. No.: 15/324,618

(22) PCT Filed: Jul. 8, 2015
(86) PCT No.: PCT/AU2015/000399

§ 371 Date: Jan. 6, 2017

(30) Foreign Application Priority Data
Jul. 8, 2014 (AU) 2014902640

(51) Int. Cl. G06F 3/01; G06F 3/02; G06F 3/0354

(52) U.S. Cl. CPC G06F 3/014; G06F 3/03543; G06F 3/0227; G06F 2203/0381; G06F 3/0482

(57) ABSTRACT

A computing device in the form of a personal computer includes three ports for receiving user commands from three user controller components. The components take the form of a hand mounted device, a keyboard and a mouse. The computer also includes memory for storing primary software in the form of user application target elements and supplementary software including a facilitation extension software, wherein the extension software is configured to be associated with, amongst other devices, the hand mounted device.

### FIELD OF THE DISCLOSURE

The present disclosure relates to systems and methods for implementing a user-actuated controller device for use with a standard computer operating system having a plurality of pre-existing applications. Embodiments of the disclosure have been particularly developed for use with personal computer systems that utilise mouse and keyboard controllers. While some embodiments will be described herein with particular reference to that application, it will be appreciated that the disclosure is not limited to such a field of use, and is applicable in broader contexts.

### BACKGROUND

Any discussion of the background art throughout the specification should in no way be considered as an admission that such art is widely known or forms part of common general knowledge in the field.

The present ‘standard desktop interface’ is the basis of the modern computer interface. This interface was introduced around 1981 by Apple and implemented soon after for the generic IBM PC as Microsoft Windows. The standard desktop interface is also known as the ‘point and click’ interface, G.U.I. (graphical user interface), and WIMP interface (windows, icons, mouse and pull-down menus).

The interface is well known and is loosely built around the notion of a graphical depiction of software objects that firstly shows the present (ongoing) status of certain software parameters and data, and secondly includes a screen (or system) pointer object the location of which is controlled by a user operated device (generically, a ‘mouse’) allowing the user to select or manipulate objects or execute commands, which the objects themselves represent.

The standard hardware configuration consists of a screen, a ‘pointing device’, and a keyboard for the direct entry of characters and as an optional means of executing commands and adjusting variables.

The other primary characteristic is the provision of a ‘shell program’ (part of the operating system), which as well as maintaining system-level facilities such as disk files and other services, acts as a container for the particular applications that the user might choose to run simultaneously, and incorporates the same methods and general appearance as the programs it supports.

Despite its overall usefulness and pervasive influence, this style of interface has some acknowledged flaws and shortcomings. These tend to fall under two broad headings, which are further subdivided:

Firstly there are ergonomic shortfalls. Despite the usual provision of two standard devices (‘mouse’ or other pointing device, and keyboard), the physical interface is essentially one-handed and serial. The ergonomics of the standard devices themselves is also an issue but is less relevant to this discussion, which centres on systemic problems.

Also, operations can presently be performed using only one hand. Many of the available actions (tasks etc) may be performed by either hand (such as optional command methods), and some require both hands (modifier key and mouse) etc. But neither of these amounts to two-handed-ness, with the two hands acting cooperatively to perform a task more efficiently than with (either) one hand alone, as for many everyday actions (for example using dining utensils, tying knots, drinking coffee while talking on the phone etc).

Opportunities for two-handed operation that do exist—for example using the arrow keys with the left hand while selecting items with the right, switching tools via the left and manipulating them with the right etc—tend to be capricious and contrived. Furthermore, these operations are not specifically designed into the repertoire of actions, and rarely optimal even where preferred.

Seriality of the interface (as opposed to that of the underlying computing process itself) is magnified by the generic low-level nature of individual sub-commands and actions (which must be strung together in lengthy sequences in order to achieve productive ends), and exacerbated by the one-handed physical means available. These physical parameters of the standard interface impose a fundamental limit on utility, since a user's productivity is ultimately dependent on their ability to actually perform the actions required.

There are also spatial shortcomings with the existing interface. Although the visual nature of the display is an advantage, the immediate visibility of objects is limited by the available screen space. Access to objects requires either screen traversal, and/or navigation to other areas of ‘application space’, which constitutes unproductive overhead. In fact, the accessing of objects with the pointer is the primary source of user overhead, (where the actual selection and/or adjustment of a variable or execution of a parameter etc. is the actual productive end, yet contributes only a fraction of the overall time and effort involved).

Accessing-type actions include document navigation and other purely visual procedures that may not even result in further actions. The number of such actions that must be completed for a given task is necessarily large in view of the generic flexibility that applications (must) offer, and the increasing number of functions and features available.

The provision of features, variables, options and document space etc. is a positive indication of functionality and flexibility. But accessing these objects and nested spaces is a major source of overhead resulting directly from the conceptual scheme itself and imposes a severe limit on efficiency, productivity and overall coherence.

It is noted that this problem of access (or lack of) is not directly a physical issue, but rather pertains to the organisational method that makes the physical access problem so disproportionate.

Other specific design issues might well be cited, and these may vary across different applications and tasks, but those mentioned above are attributable to the general scheme and are common to most applications.

Interestingly, the path to significant system-wide solutions, or indeed to changes of any sort, is blocked by the co-dependence of various elements that constitute the system itself.

The configuration of standard physical (hardware) devices (mouse and keyboard), as well as the functions they perform (moving a system pointer, executing certain actions etc.), is highly resistant to alternatives, for two reasons:
The operating system (OS) allows applications to be written on the assumption that certain devices are likely to be present and these devices (and functions) are mandatorily supported.
Any functional innovations of the devices is blocked by the need for backwards compatibility. So removing, replacing or fundamentally altering the standard devices and their operation renders the system unusable for pre-existing applications.

In principle, applications are free to utilise any device or devices, in whatever way they please. But this does not offer a systemic development path, since naturally the vast majority of applications are pre-existing and any solution that does not cater for them is hardly ‘systemic’. This pragmatic reality probably explains why the standard desktop interface has changed so little and continues to employ much the same set of devices, functions and on-screen appearance, with incremental shifts in the conventions and methods employed.

There is currently considerable interest in ‘human interface devices and methods’, yet most innovations to date have been of three kinds:
1. Alternative Devices: This includes both minor enhancements and radical revisions to the form and/or performance of the existing devices, but which necessarily perform the same or equivalent functions as a traditional mouse and/or keyboard. This path is limited by the pragmatic considerations of compatibility mentioned above: it amounts to providing better, rather than different devices and includes all manner of optional ‘pointing devices: trackballs, pads, tablets/stylus, ergonomic super-mice etc. including gesture-systems and touch screen technologies. All of these merely offer alternative (if improved) physical means of moving the system pointer or carat, or offer keyboard commands and function in a similar sense.
2. Software-based Methods: These take the form of either application-specific methods and graphics (for example right-click, spacebar or hotkey triggered arrays of menu options at the pointer location, customisation schemes for programming shortcuts and function keys etc.), or else OS/session level utilities that allow for a variety of similar or extended functions from anywhere around the interface and desktop. These methods, however, are confined to using the same physical devices and are therefore limited by the considerations above, but from the perspective of software rather than hardware.
3. Dedicated Devices and Applications: This includes different devices and methods, including motion-capture and virtuality systems, games consoles, musical instrument (MIDI) applications, and any other setup that offers custom or purpose-specific functionality with appropriate devices and matching software. But this path does not offer a solution or alternative to the standard paradigm. Rather it relies on specifically breaking with convention, and such solutions—whether of hardware or software—are not universally applicable to other (pre-existing) applications or devices.

One of the closest known devices is the Peregrine iGlove, which is an ‘additional, left-handed, glove device’, but nevertheless amounts to a ‘type-1’ innovation (that is, an alternative device) insofar as it is identified or recognised by the system (and hence, by applications) as a keyboard. It should be noted that neither the mouse nor keyboard are ‘universal’ as defined; they are merely standard because they are well supported. Thus, the iGlove's ‘universality’ is likewise merely ‘standard’, and is non-innovative in the sense that it is not differentiated from a standard keyboard.

Several other ‘glove-devices’ exist but most are either intended for the right-hand as an alternative pointer devices, for both hands as a gesture-based, or cursor/object manipulators, or for dedicated applications such as Virtual Reality (VR) graphics, medical or industrial manipulators, or pressure/force/orientation sensitive applications.

No existing universal devices are known, glove-based or otherwise.

### SUMMARY OF THE DISCLOSURE

It is an object of the present disclosure to overcome or ameliorate at least one of the disadvantages of the prior art, or to provide a useful alternative.

A first embodiment provides a method for implementing a user-actuated controller device for use with a standard computer operating system having a plurality of pre-existing applications, including the steps of:
loading supplementary software onto the computer operating system such that the supplementary software integrates with the pre-existing applications wherein the integration includes creating one or more configurable command lists corresponding to a particular pre-existing application whereby the lists are accessed by the controller; and
providing the controller device associated with supplementary software, the device including at least one actuator for accessing the one or more configurable command lists, wherein the controller is for use simultaneously with a mouse and a keyboard.

In an embodiment, the controller device is a hand actuated device design.

A second embodiment provides a computing device including:
at least one port for receiving user commands from at least two user interfaces, wherein one of the user interfaces is, in use, a hand mounted interface;
memory for storing primary software and supplementary software, wherein the supplementary software is associated with the hand mounted interface;
a processor that is responsive to:
   (a) the primary software and the supplementary software for allowing the two user interfaces to contemporaneously operate; and
   (b) the supplementary software for changing to the primary software to facilitate the contemporaneous operation.

In an embodiment, the hand mounted interface includes at least two pressure sensors located on the hand mounted interface, and wherein the sensors are opposable to the tip of at least one digit.

In another embodiment, the supplementary software provides at least one customizable command menu to be used with the primary software thereby extending the operational and functional capabilities of the pre-existing personal computer.

In embodiments, the controller device is a garment worn on the hand.

A third embodiment provides an operating system for use with a computing device having: hardware including a keyboard and mouse; and at least one pre-existing generic software program, the system including:
a user device for use in conjunction with the keyboard and mouse; and
customizable user device software integratable with the pre-existing generic software program for providing at least one customizable command option to be used with the pre-existing generic software thereby extending the operational and functional capabilities of the pre-existing personal computer.

In an embodiment, the device software includes a plurality of menus each corresponding to a particular one of the at least one pre-existing generic software program, for use with the corresponding program. In a further embodiment, each menu includes a plurality of tasks.

A fourth embodiment provides a user interface for operation with a computing device, the interface mountable to a hand of a user and including:
a mounting element conformable to the hand for mounting to the hand;
at least one button located on the mounting element wherein, in use, the at least one button is located on an area of the mounting element adjacent the metacarpals of the hand for being actuated by at least one of the distal phalanges of the hand.

In an embodiment, the user interface includes a plurality of buttons wherein at least one button is located on an area of the mounting element adjacent the intermediate phalanges of the hand.

In another embodiment, the user interface includes a plurality of buttons wherein at least one button is located on an area of the mounting element adjacent the proximal phalanges of the hand.

In an embodiment, the mounting element leaves at least one distal phalanges of the hand uncovered when mounted to the hand. In a further embodiment, the mounting element all distal phalanges of the hand uncovered when mounted to the hand.

A fifth embodiment provides a method for implementing a computer interface controller for a standard computer operating system, including the steps of:
loading software onto a computer;
integrating the software with existing software;
plugging in the controller to be used, wherein controller is a device to be used in addition to a mouse and a keyboard.

One embodiment provides a computer program product for performing a method as described herein.

One embodiment provides a non-transitive carrier medium for carrying computer executable code that, when executed on a processor, causes the processor to perform a method as described herein.

One embodiment provides a computer system configured for performing a method as described herein.

A sixth embodiment provides a control system for controlling one or more pre-existing user applications running on a standard computer system, the control system including:
at least one user interface; and
computer-system-level supplementary software for integrating with the one or more pre-existing user applications to enable the at least one user interface to at least partially control the one or more pre-existing user applications.

In an embodiment, the the at least one user interface includes an intermediary interface application integratable with the one or more pre-existing user applications for providing a customizable set of uniquely executable user operations. In another embodiment, the the at least one user interface includes at least one on-screen visual display element viewable by a user.

In an embodiment, the the at least one user interface includes a user control device configured to be used by a user's non-dominant hand such that the user control device is operable simultaneously and in conjunction with one or more existing controller devices. In another embodiment, the the user control device is a glove.

In an embodiment, the one or more existing controller devices include one or more of the group consisting of: a pointing device; and a keyboard. In an preferable embodiment, the pointing device is a computer mouse.

A seventh embodiment provides a method for extending the functionality of a user interface for one or more pre-existing user applications of a standard computer system, the user interface including at least one uniquely identified user controller device, wherein the one or more pre-existing user applications includes a plurality of target commands, the method including:
connecting the at least one uniquely identified user controller device to the standard computer system; and
loading a supplementary interface application onto the standard computer system, the supplementary interface application being used to control the one or more pre-existing user applications and allow the user controller device to selectively execute the target commands, wherein the user interface further includes at least one on-screen visual display element viewable by a user.

An eighth embodiment provides a method for carrying out a desired operation on a standard computer operating system using a first control device and a second control device, the method including:
carrying out a first predefined action with the first control device that both executes a first command and establishes a predefined recognised first state for the operating system, wherein the first state provides a first set of subsequent predefined commands;
based on the first set of subsequent predefined commands of the predefined recognised first state, carrying out a second predefined action with the second control device that both executes a second command from the set of subsequent predefined commands and establishes a desired recognised second state for the operating system, wherein the second state provides a second set of subsequent predefined commands; and
based on the second set of subsequent predefined commands of the desired recognised second state, carrying out a third predefined action with the first control device thereby carrying out the desired operation, wherein the devices are usable simultaneously and in conjunction.

A ninth embodiment provides a method for carrying out a desired operation on a standard computer operating system using a first control device and a second control device, the method including:
carrying out a first predefined action with the first control device that both executes a first command and establishes a predefined recognised first state for the operating system, wherein the first state provides a first set of subsequent predefined commands;
based on the first set of subsequent predefined commands of the predefined recognised first state, carrying out a second predefined action with the second control device that both executes a second command from the set of subsequent predefined commands and establishes a desired recognised second state for the operating system, wherein the second state provides a second set of subsequent predefined commands; and
based on the second set of subsequent predefined commands of the desired recognised second state, carrying out a third predefined action with the second control device thereby carrying out the desired operation, wherein the devices are usable simultaneously and in conjunction.

In an embodiment, there is included a target application configured for use on the standard computer operating system wherein the desired operation executes a command on the target application.

In an embodiment, the first control device includes at least one depressible button resiliently biased into a non-depressed position, and the first predefined action includes depressing the button. Preferably, the predefined recognised first state is maintained by holding the button in the depressed position. More preferably, the third predefined action includes releasing the button allowing the button to return to the non-depressed position.

In an alternate embodiment, the first control device includes at least one depressible button resiliently biased into a non-depressed position, and the first predefined action includes depressing and releasing the button.

In another alternate embodiment, the first control device includes a pointing device having a cursor, and the first predefined action includes positioning the cursor in a predefined location. In an embodiment, the pointing device is a computer mouse.

In an embodiment, the second control device includes at least one depressible button resiliently biased into a non-depressed position, and the second predefined action includes depressing the button. Preferably, the predefined recognised second state is maintained by holding the button in the depressed position. More preferably, the third predefined action includes releasing the button allowing the button to return to the non-depressed position.

A tenth embodiment provides a class of predetermined user device actions for navigating and executing available options and commands for a target computer application wherein the device actions including performing the method of the ninth embodiment.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the disclosure will now be described, by way of example only, with reference to the accompanying drawings in which:

FIG. 1 schematically illustrates a system for implementing a user-actuated controller device.

FIG. 2 schematically illustrates the system of FIG. 1 and also shows the interactions between components.

FIG. 3 is an orthogonal view of a hand mounted device of FIG. 1.

FIG. 4A is a graphical representation of a tandem action with two devices.

FIG. 4B is a graphical representation of another tandem action with two devices.

FIG. 5A is a graphical representation of a ‘multiple event’ action specifically, showing the timing of “hold then hold” action.

FIG. 5B is a graphical representation of a ‘multiple event’ action specifically, showing the timing of “hold then tap” action.

FIG. 5C is a graphical representation of a ‘multiple event’ action specifically, showing the timing of “tap then hold” action.

FIG. 5D is a graphical representation of a ‘multiple event’ action specifically, showing the timing of “tap then tap” action.

FIG. 6 is a conceptual representation of the software display of the system of FIG. 1 showing a Task Assignment Panel and associated panel-style displays.

FIG. 7 is a conceptual representation of the software display of the system of FIG. 1 showing a panel-style display.

FIG. 8 is a conceptual representation of the software display of the system of FIG. 1 showing a multiple panel-style display.

FIG. 9 is a conceptual representation of the software display of the system of FIG. 1 showing a menu.

FIG. 9 is a conceptual representation of the software display of the system of FIG. 1 showing a menu.

FIG. 10 is a conceptual representation of the software display of the system of FIG. 1, specifically a panel-style display showing the re-assigning of tasks.

FIG. 11 is a conceptual representation of the software display of the system of FIG. 1, specifically a panel-style display showing the assembling of sets and menus.

FIG. 12 is a conceptual representation of the software display of the system of FIG. 1 showing a global library listing.

### DETAILED DESCRIPTION

Described herein are systems and methods for implementing a user-actuated controller device for use with a standard computer operating system having a plurality of pre-existing applications.

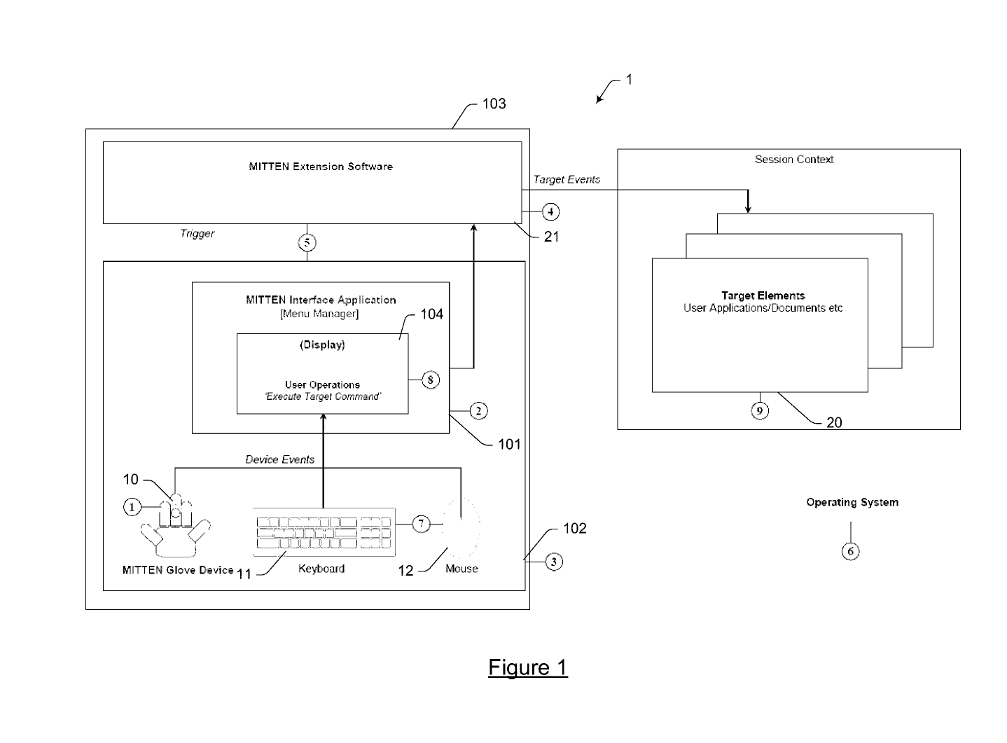

Referring to FIG. 1, there is illustrated a computing device in the form of a personal computer 1 including three ports (not shown) for receiving user commands from three user controller components. The components take the form of a hand mounted device 10 (also referred to as the Mitten Glove Device), a keyboard 11 and a mouse 12. Computer 1 also includes memory (not shown) for storing primary software in the form of user application target elements 20 and supplementary software including a facilitation extension software 21, wherein software 21 is configured to be associated with, amongst other devices, hand mounted device 10.

Computer 1 also includes also includes a processor (not shown) that is responsive to:
Elements 20 and software 21 for allowing the three user controller components to contemporaneously operate; and
Software 21 for changing to elements 20 to facilitate the contemporaneous operation.

In other words, the processor responds to software 21 to allow the contemporaneous operation to be usefully applied to elements 20.

Computer 1 includes a conventional operating system (OS) run on a conventional, commercial personal computer. The OS is understood by those skilled in the art to include, or have access to, any and all hardware, firmware, or other components (processor, BIOS, memory, disk storage etc) required to support the other elements depicted.

In other embodiments, there is more or less than three ports on computer 1. In yet other embodiments, there is more or less than three user controller components. In other embodiments, the components are other than device 10, keyboard 11 and mouse 12. It is mentioned that a mouse click is defined as pressing and releasing a button on mouse 12.

Furthermore, computer 1 includes a display 104 that takes the physical form of a video (VGA) screen, but generically refers herein to any and all user output presentation peripherals, visual, audio, and tactile amongst others. Display 104 is accessible to, and shared by, any or all user software elements of computer 1.

Software 21 is configured to be associated with any number of devices including device 10. For example, in an embodiment, software 21 is configured to be associated with a steering wheel controller.

Device 10 is installed via appropriate software driver and recognised as a unique device by computer 1. Device 10 is available to any conventionally installed applications that support its device events (explained in detail below).

Although in this embodiment a standard keyboard 11 and mouse 12 are used, we note that in other embodiments, mouse 12 is another type or system of pointing device (such as a tablet, ball, pad, or touch-screen, amongst others). These devices are assumed to be connected, installed and supported by any one or more pre-existing applications (target elements 20).

Target elements 20 are pre-existing user software that is installed on the OS of computer 1. Elements 20 need not be active all the time and each include one or more parameters and/or values that can be accessed, viewed (that is, represented as display states), controlled, adjusted or affected by a user (via a user controller component). Elements 20 include applications, documents, tools, and utilities, amongst others. Elements 20 include pre-existing generic software programs and include but are not limited to MS Word, MS Excel and Internet Explorer, amongst others.

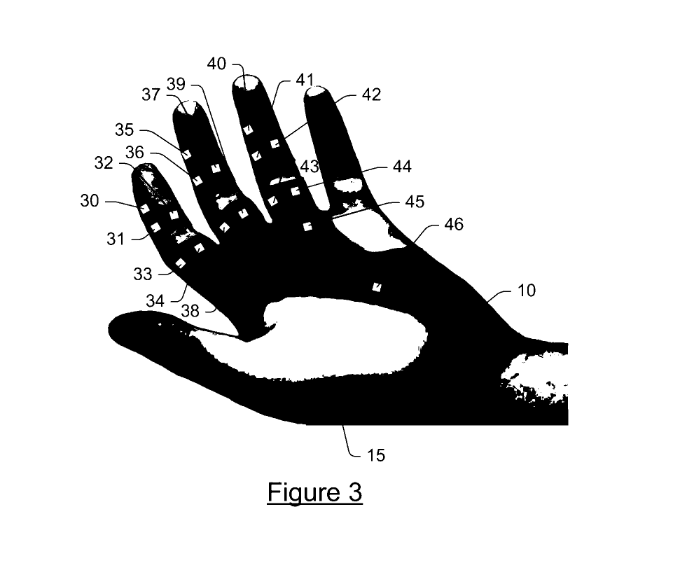

Referring to FIG. 3, device 10 includes seventeen pressure sensor buttons shown by reference numerals 30 to 46 mounted on device 10. The sensors are opposable to the tip of at least one digit of a left hand 15 of the user. As shown in FIG. 3, device 10 is a slip-on garment that in use is worn on hand 15. It is emphasised that device 10 is to be used in conjunction with keyboard 11 and mouse 12. As such, in this embodiment, device 10 is designed to be used on the left hand of the user. However, in other embodiments, device 10 is configured to be used on the right hand of the user. In yet other embodiments, device 10 is a reversible glove garment that can be worn on either hand. In yet other embodiments, there is two devices that can be simultaneously worn and used on both the left and right hands.

The buttons located as follows:
One button 30 located on an area of device 10 adjacent the distal phalanges of the index finger of the hand.
Two buttons 31 and 32 located on an area of device 10 adjacent the intermediate phalanges of the index finger of hand 15.
Two buttons 33 and 34 located on an area of device 10 adjacent the proximal phalanges of the index finger of hand 15.
One button 35 located on an area of device 10 adjacent the distal phalanges of the middle finger of hand 15.
Two buttons 36 and 37 located on an area of device 10 adjacent the intermediate phalanges of the middle finger of hand 15.
Two buttons 38 and 39 located on an area of device 10 adjacent the proximal phalanges of the middle finger of hand 15.
One button 40 located on an area of device 10 adjacent the distal phalanges of the ring finger of hand 15.
Two buttons 41 and 42 located on an area of device 10 adjacent the intermediate phalanges of the ring finger of hand 15.
Two buttons 43 and 44 located on an area of device 10 adjacent the proximal phalanges of the ring finger of hand 15.
One button 45 located on an area of device 10 adjacent the palm, just below the proximal phalanges of the ring finger of hand 15, opposable by the thumb of hand 15.
One button 46 located on an area of device 10 adjacent the palm of hand 15 that is opposable by either the ring finger, the middle finger and/or the little finger of hand 15, respectively.

Buttons 30 to 44 are designed to be actuated by the thumb of hand 15 and are collectively referred to as task buttons. Button 45 is also designed to be actuated by the thumb of hand 15 and button 46 are designed to be actuated by a clasping motion. Buttons 45 and 46 are collectively known as utility buttons and respectively referred to as the auxiliary (AUX) and palm (PALM) buttons. Whenever a button is pressed, this triggers what is referred to as a ‘glove event’. Similarly, when a key on the keyboard is pressed this is referred to as a ‘keyboard event’ and when a mouse button is pressed this is referred to as a ‘mouse event’. A ‘device event’ refers to any glove, keyboard or mouse event (or an event from any other device).

It is noted that, although the buttons are mounted in such a fashion that their position is designed to be accessible to a particular digit, it is appreciated that any user can actuate the buttons during operation of device 10 by any means that their unique anatomy allows. For example, button 46 can be actuated by any digit that is opposable to those buttons, not just the ring finger, the middle finger or the little finger of hand 15. For example, a user can actuate button 46 with their index finger.

In other embodiments, there are more or less buttons. In yet other embodiments, the buttons are arranged in a different layout to that which is illustrated herein.

Device 10 provides an additional, unique set of user input events (namely, button press and lift events, and held states) that are used, along with keyboard 11 and mouse 12.

Device 10 leaves all distal phalanges of hand 15 uncovered when mounted to hand 15. In other embodiments, device 10 leave less than all five distal phalanges of hand 15 uncovered when mounted to hand 15.

Electronics located on the back of hand 15 (which are not shown) include a small computer processor and memory cache (amongst other components) for the buttons, battery power and charging circuits, and standard (2.4 Ghz) wireless TX which is received by a USB RX dongle either attached to computer 1 or incorporated in computer 1.

Device 10 is a simple button-operated garment device that offers significant ergonomic advantages and complements the existing arrangement by adopting a characteristically left-hand (non-dominant hand) or ‘assist’ role in tandem with the other devices. It is emphasised that the design of device 10 provides enough freedom and dexterity to the user that is can also be worn on the dominant hand without inhibiting overall efficiency.

The buttons of Device 10 include a mechanism of an elastic membrane over sealed air-pocket (above a foil dome switch or tracks with conductive layer on the membrane interior). The air pocket keeps the upper and lower surfaces apart, even when laterally compressed. It will be appreciated by those skilled in the art that the other buttom mechanisms are used in other embodiments.

Removal from hand 15 of device 10 is done in a variety of ways, three embodiments being:
Velcro spots on the upper extremity of each finger of device 10, engaged with a matching piece (for example, attached to a surface, or a tool), to ‘tear-off’ device 10.
Tabs on the upper finger surfaces that are either loops, or that extend (by unhooking or unfolding) and long enough to be held together for sliding device 10 off in one movement.
Attached ‘bridges’ between each pair of fingers of device 10 (long enough to allow the fingers to be fully spread) that could be grasped or hooked with fingers of the other hand of the user.

It will be appreciated by those skilled in the art that the other such removal methods are used in other embodiments.

Mitten actions are the set of available user input actions recognized by an interface application 101. A mitten action can involve one or more physical actions (such as a button pressed down and lifted, or a keystroke on keyboard 11), or physical actions and states with two or more devices (such as a double button press, or double mouse click).

Device states provide a context for optional concurrent events and outcomes (such as a mouse click while a button is held down), referred to herein as tandem actions.

Physical actions associated with the buttons of device 10 are known as button actions. The button actions are as follows:
Hold or Held action which comprises a button press and subsequent hold, maintaining the held state where the button is depressed. If the held state is of a minimum duration, then the subsequent button lift (see next point) can be used to trigger a separate, independent outcome. It is noted that the user can designate a minimum delay time, for example, 200 ms. Notably, the held state facilitates tandem actions by defining a condition that can be used to modulate possible concurrent events that may occur (possibly, from other devices etc) as well as the eventual outcome from the Lift event.
Lift action, referred to above which comprises the release of the button that always follows a hold action. As mentioned, the effect of lifting a pressed button may be contingent on events occurring after the button was pressed, and the states prevailing when it is lifted. The lift action is used as a technique for providing users with selectable options.
Tap action is a ‘single event’ action, where a pressed button is released within a predefined delay time. The initial physical action is the same as for the hold action, but the timing of the lift action is distinguishable from the hold action.
There are also infinite permutations of ‘multiple event’ actions (for example double-press, re-press, re-lift, re-tap), conditional sequences (for example same/different button/device next, or other sequence).
There are also infinite permutations of non-standard mouse and/or keyboard actions, for example, click left mouse while right mouse is down, two or more keys down concurrently, varying orders of releasing held buttons/keys, amongst others.

As mentioned previously, tandem actions are user actions involving (at minimum) an event during a concurrent defined state (for example, a mouse-click during a button hold). A tandem state is any suitably defined condition (for example device states, pointer location, prior actions), yielding a large number of unique, recognizable, instantaneous state of affairs to which the system can (uniquely) respond.

A class of user device actions for navigating, viewing, selecting and executing available options and commands (of a computer application) that rely on the system recognizing and responding to: (a) whether and which certain device event or events occur concurrently with some given state of another device; and (b) the order in which the events occurred, where the effect of each subsequent event (that is, the change of state) may be dependent on any or all of the prior events in a given sequence. A given discreet sequence of such events and concurrent states is referred to a tandem action.

In one embodiment, a set of tandem action conventions consists of some or all of the following example tandem actions:
a) a convention where pressing and holding a button routinely causes some display, page, object, menu, or window, amongst others, to firstly appear and then to remain visible on screen, for as long as the pressed button is held down;
b) a convention where a held display (as in example a) above) is routinely cleared from screen, unless say a mouse button is clicked anywhere on screen, prior to the held button being released (that is, lifted), and in the event which the displayed display, page, object, menu, or window, amongst others remains visible on screen thereafter (that is, is latched on screen);
c) a convention where ‘tapping’ (quick pressing and substantially immediate releasing) of a button causes a display, page, object, menu, or window, amongst others (as in examples a) and b) above) to be displayed and automatically latched on screen;
d) a convention where the location of the pointer is used to determine where a display, page, object, menu, or window, amongst others (as in examples a) to c) above) first appears on screen;
e) a convention where any ‘undo-able’ program outcome is executed only when a button is lifted never when it is pressed;
f) a convention where (contrary to example b) above) mouse-clicking a held display (but not a latched one), rather than clicking outside the displayed area, causes the system to instantiate an ‘editing’ or utility mode, or causes an additional related display to appear, or some other result;
g) a convention where the instantiation of ‘utility mode’ (as in example f) above) routinely causes a change in the functions assigned to the various buttons;
h) a convention where the system recognises when two (or more) buttons are concurrently down, and distinguishes the different ways in which the situation could have come about, and the different ways (orders) in which the buttons could all become released, and furthermore, whether the button that was pressed first was released last, or whether the (for example two) buttons were released in the same order that they were pressed (and so forth), or whether something else happened (for example, a lifted button was pressed again while the other button remained down);
i) a convention where repeatedly clicking a mouse anywhere on screen while a button is held down (and is hence holding a display visible on screen, as in example a) above), causes: an alternate display to appear in place of the first and to toggle back and forth between the two, or to cycle through a number of different displays, or to move the focus between two or more displays, both of which remain visible, or, to move the focus or select different items or options within one or both displays, amongst others.
j) a convention where, (as in example i) above), lifting the held button causes the currently selected item (that is, having been selected by repeated mouse-clicking of the screen) to be ‘executed’;
k) a convention where rolling the pointer over an object or a series of objects causes an additional display (window, for example) to appear showing the contents or details (amongst others) of each rolled object in turn; and/or
l) a convention where the type or category of content shown (as in example k) above) depends on whether and which of certain designated optional other devices are concurrently active or in a particular states (for example, rolling a list of menu names opens a second box showing the items in each menu in turn, and/or where if a button is concurrently held while rolling, the info shown is either different, augmented, truncated, or displayed differently, amongst other possibilities);
m) a convention where clicking anywhere or somewhere on screen, the currently displayed info is held after the pointer is moved off the source item, and/or a further additional window or box is displayed again showing the details of each object rolled (as in example k) above);
n) a convention where in one mode, operating any available device serves to assign a subsequent function to that same device, and/or to alter its own subsequent behaviour and/or to alter its own subsequent effect on other events and states, when returned to the original or to a second mode;
o) a convention where the effect of lifting a held button (or more generally of any event or resulting state of a given device) can be selected from a number of possible options depending on whether and which of one or more designated events occur prior to the event or change of state in question); or
p) a generalised convention in which: (i) each and every variant of rolling, clicking, pressing, holding, dragging or any other possible event or state using any one or more available devices, either/and/or consecutively and concurrently, can be used to cause a change in a program or interface state, and where (ii) each and every variant in the history of the events of states in (i) can be used to cause a change in a program or interface state, and (iii) a tandem event or state (as described herein) may have a particular effect whether or not in response to or according to the current program or interface state or the state of the display or the currently active field on screen or the location of the pointer or in general the current context, that is the effect of a tandem action may be independent of everything other than the physical movement or operation of the physical devices themselves.

Typically, a commenced tandem action allows a constrained tree of possible outcomes (or optional behaviours), which the user can select by performing the appropriate actions. For example, pressing and holding a button to pop-up a menu can allow the user to optionally view, clear, latch, move, execute, or edit, amongst others. All such actions are available during the button held state, prior to lifting. Optional effects of lifting the button may also be determined by events during the held state.

Useable states and events are multiplied using the location of the pointer of mouse 12 (known as a pointer zone) to modulate other device events and states. Pointer zones are often large, even non-contiguous regions or windows for example, anywhere inside or outside any element type, or anywhere on the ‘screen’ (in the case of mouse clicks), but include, for example specific icons. Pointer zones can be conditional states (such as pointer at location X when event Y is triggered), or events (such as clicking at location X while in state Y). In preferred embodiments, the two main permutations of actions relating to pointer zones are: hold button and then click mouse (a tandem action); and point mouse pointer and press/hold/tap button (referred to herein as a panel action).

Tandem actions contrast with conventional methods (such as a mouse roll-point-click on screen icons, menus etc) in that related options are made available in context. Furthermore, events may be modulated ‘on the fly’ which, altogether resulting in efficiently exploiting more permutations of events and states. They only superficially resemble key-modifiers.

It is noted that tandem actions and conventional modifier actions (made by holding one key, such as Shift, Ctrl and Alt, and pressing another) both involve at least one device event concurrent with another device on-state where the outcome of the event is dependent upon the underlying device state (that is, the depressed modifier or modifiers, held button or other device state). This common feature alone, however, does not make them similar types of action. Firstly, there are only a limited number of physical events and states possible using simple keyboard and mouse buttons. As such, having two (or more) devices in the down state at a particular time is not an especially significant similarity. For a proper comparison, it is necessary to examine the whole evolution of each action and what is accomplished at each step.

So-called standard ‘modifier actions’ (for example Shift+keystroke, Shift-Alt+mouse-click, Ctrl-drag) do also involve a certain type of case where the state of one (or more) devices can affect the outcome of subsequent events from other devices, insofar as the outcome may be different that what would have occurred otherwise.

However these actions do not functionally rely on concurrent states and are constrained by:
a) the functional nature of the modifying agents/keys: pressing a modifier key ostensively does nothing by itself (although it will sometimes present a visual cue of what is going to happen, it never actually performs an ‘undo-able’ operation), so they cannot be used to execute program commands. Conversely every event in a tandem action can execute a program command. Only the designated keys (Shift, Alt for example) can by used as modifiers. Conversely, any device can be used perform any role in a tandem action.
b) the conditions that must pertain for a result to take place: the relevant one or more modifier keys must all be down either at the onset or the completion of the event or events to be modified. They cannot be released before or after the event in question. Also, the order in which modifier keys are depressed or released is ignored so only combinations of modifier keys, not their permutations, are distinguished (for example Shift+Alt is equivalent to Alt+Shift).

Because the modifiers do nothing by themselves and must be applied prior to the event to be modified, they do not allow the user to choose a course of action based on the results obtained from commencing the process itself. A tandem action commences by presenting a program state from which the user can choose two (or more) optional paths, and this same decision process can be continued for each subsequent event in a given sequence (that is in a given tandem action).

This allows tandem actions to perform a qualitatively distinct role—that of providing a navigation and selection system, rather than merely button function switches.

We note that the term ‘active event’ as used herein refers to a modified event or device function in a modifier action. The term ‘tandem event’ as used herein refers to the corresponding term in a tandem action. The term ‘modifier state’ as used herein refers to the combination of held modifier keys when an active event occurs. The term ‘tandem state’ as used herein refers to the particular state of the system (or context) following each event in a tandem action. An onset event is defined as that which sets the onset state (or initial context) in which subsequent tandem events may occur; if such an event does occur the onset state is then also a tandem state. The equivalent onset event or events of a modifier action perform no independent functions.

There are perhaps three key differences worth mentioning: the first is that in a tandem action, the onset event sets a context (for example, opens a window, enables a mode or functionality) in which one or more optional and/or subsequent concurrent events are then available to produce some outcome that is particular to that context. By contrast, pressing a modifier key does not, and cannot, set a context, simply because modifier keys do not provide a function when used on their own; the context in which the active event occurs is already set. It is noted that this availability of relevant or ‘particular’ outcomes contrasts with conventional methods where the entire gamut of commands options remain presented, even though many would be un-usable in the precisely given context. For example, an ‘edit object’ command makes no sense, or can play no role, unless an object of the relevant type actually exists and is selected or visible etc at the given time.

To ‘set a context’ essentially equates to changing the current context to some other context. In the precise sense, this might include not just wide contexts like ‘the current application’ but narrow contexts, such as the particular object, field or tool, that is presently active or current in a similar sense to ‘session context’ (as will be described in detail herein).

In this sense, the set of tandem events are intended to be contextually relevant (and exhaustively so). With modifiers, the active events are relevant insofar as the commands they select are sensible in the current context, but they are not contextually particular in the narrower senses and they cannot represent a coherent set of relevant commands, nor can they possibly represent the only relevant commands. Tandem actions present a focussed, particular set of available commands specifically relevant to the context.

This is important because tandem actions by contrast constitute a method for presenting a set of commands in the user-chosen context, where the commands are highly focussed and specific to that particular context in the narrower sense.

Another key difference between tandem actions and modifiers is that the modifier state itself, rather than the active events, determines the function applied (to those active events). That is, all the active events in a given modifier action tend to yield a similar outcome (or similar type of outcome), according to the particular modifier function defined. For example, where the ‘Shift’ key applies the function: ‘upper case’ to all subsequently pressed character keys; ‘Ctrl’ and drag/release with the mouse pointer applies the copy function to any subsequent target objects of the appropriate kind, or (as in Photoshop for example) ‘Shift’ and a keystroke changes the cursor tool to its optional alternative, even if there are exceptions to this rule. Tandem actions specifically do not work this way; on the contrary, apart from setting the context and hence the range of (tandem) functions available, each tandem event is usually assigned a very different function for example, Execute item, Abort action, Edit menu, Edit item, Re-assign button-task, Open Preferences, amongst others. These are not just an optional or consecutive set of generically similar outcomes as is the case generally for modifiers.

It will be appreciated by those skilled in the art that such a distinction is significant because tandem actions enable not just a single command, or type of command, to be applied to a number of instances (of active events), but a variety of commands, in the selected context.

Yet another key difference between tandem actions and modifiers is that tandem events themselves can, and very frequently do, set a new context, enabling a corresponding set of new optional commands. Thus, a tandem action can chain from one context to any of a range of others (and back again if desired), each with its own set of tandem events and corresponding set of commands. This potential navigation of a tree of possibilities has no analogue whatsoever in modifier actions, and is more reminiscent of a conventional movement through an application's space (that is, the ordered set of tasks that achieves the user's intended result). Tandem actions are intended for just this: using a different conceptual method that relies more on different types of physical action (such as, click while press, press while hover, lift button while mouse down, release mouse after button lifted, click anywhere on screen) rather than a series of generically similar types of action (roll, click, roll, click . . . ) applied to a sequence of different objects.

These key differences underlie the essential nature of tandem actions, and at same time highlight how they differ from conventional methods, not only modifier actions (to which they might erroneously be likened) but to the other sorts of actions and methods we associate with standard graphical point and click interfaces.

Putting the differences together we get, in the case of tandem actions, the capacity to firstly set (or change to) a particular context (for example, open a window, select an object or functional mode) and to then execute one or more of a range of consecutive differing events or actions corresponding to a set of functions relevant to each context, where the actions may also serve to further change the context and enable another set of relevant functions. Modifiers are simply not intended to behave in this way, rather they tend to be confined to enabling one or more alternative functions to be assigned to a single device or action (active event), within the current context, or to enabling a single alternative function to be applied to a number of devices (such as selecting an alternate set of tools across a number of different keys). In each of these cases, the combination of modifiers held at the time determines the alternate function. Generally the actual range of options is limited, often to one, and only to a limited number of keys, but this is beside the point; the two types of action, in terms of what they accomplish from the perspective of the user and how they achieve their results, are radically different.

To take the comparison of specific mechanisms further the following relevant constraints apply to modifiers and modifier actions:
a) As mentioned above, none of the modifier keys or their events have a function of their own;
b) Also as mentioned above, a given modifier state only enables one function (even when applicable to a number of active events);
c) All modifier keys (if more than one) must be depressed before the relevant active event takes place (specifically, before an active key is pressed, or before a mouse button is released);
d) Adding a modifier key after the initial active event causes no additional result;
e) A modifier must be released only after the active event/s have occurred, that is, only modifiers still down when the active event occurs participate in the action;
f) The order in which two (or more) modifiers are pressed has no effect on the outcome of a modifier action;
g) The order in which two (or more) modifiers are released has no effect on the outcome of a modifier action;
h) Only modifier key states (never modifier events) are used to modify active events; and
i) The modifier keys are dedicated keys and no other keys or device states can be used as modifiers.

None of the above constraints applies to tandem actions. On the contrary, each of the disallowed conditions mentioned may be exploited in different ways in a tandem action.

Furthermore, there are certain capabilities of mitten actions in general that extend the list of allowed conditions and which would be inapplicable to any conventional actions.

Such actions include using both the press and release events of a button of device 10, or where an event may have both an immediate effect (executing a command) and a postponed one such as determining the effect of lifting a different device/button further along in the sequence. It is noted that a given tandem action can easily incorporate these various mechanisms without necessarily being overly complicated.

As to the overall method, it is noted also that whereas modifiers tend to merely offer an alternative way of executing a command available by other means (a key command instead of a mouse-click for example), tandem actions are the default method for operations in the Menu Manager application, even while a given outcome may be available via two alternative tandem events. For example, in a fairly typical tandem action such as: a mitten menu is held open on screen (by continuing to hold down the button that invoked it) the available tandem events cannot be described as ‘alternative’ means of executing given commands. The held button maintains the context (the open foreground menu) and any subsequent commands are all concurrent tandem events (even where alternative concurrent events may be available for example, by clicking in a mouse zone versus a keystroke versus holding the mouse down somewhere else while lifting the button).

For more involved tandem actions, the differences are even more pronounced. In some cases, several of the conditions excluded in modifier actions may occur within a single tandem action, whilst in others there is simply no equivalent action with modifiers at all. For example, a complex tandem action may proceed as follows: press and hold a task button (displays and holds open a menu), then mouse-click inside the menu (to commence some procedure), then abort the mouse click (by moving off the item), then mouse-click and hold down in a mouse region (for example outside the menu), then lift the task button, then tap the Palm button (while the mouse is still down), then release the mouse, then begin an editing operation in which buttons of device 10 are pressed when the mouse pointer is hovered over certain items. In such cases, one tandem state or context (for example the opened menu) is replaced by another state (the Palm tap which opens an editing mode or window), and by others (mouse hovering over various objects to show their contents) also accompanied by events such as button presses. The various press events can also affect what happens on lift/release events down the track, on different devices. It is noted that in some of these steps it is the mouse button that now sets the state and the glove buttons that execute the tandem events. Clearly, many of the combinations of events and states in the example given are not even possible with modifier actions.

Thus not only do each of the constraints on modifiers (particularly those listed in c) through i) above) not apply to tandem actions, but the circumstances they describe can all be applied during the course of a single tandem action (and/or panel action, which is a variant type of tandem action). To sum up, differences in mechanism between the two types of actions underlie the more important methodological difference: that tandem actions enable a set of context relevant events within the particular user-selected context that corresponds to the initial onset event.

Ergonomics and functionality dictates the best set of options and actions to provide. The simplest tandem actions involve:

1. Onset which is an event defining the tandem state.

2. Optional concurrent tandem events.

3. Constrained programmable events (for the lift of an already pressed button).

Mouse tandem actions consist of: a mouse event (left/right button press, up/down of a mouse scroller, single/double clicks, amongst others) during concurrent states (such as a particular button or key being held). Defined pointer zones multiply the number of actions.

Key tandem actions consist of: a key event (pressing of a character, number, space, f-key, etc) during concurrent state (such as task/global button held down, a mouse pointer in a pointer zone, or mouse button left/right held down, amongst others).

Button tandem actions consist of: a button event during concurrent state (such as a key/mouse button held down, a mouse pointer in a pointer zone, amongst others).

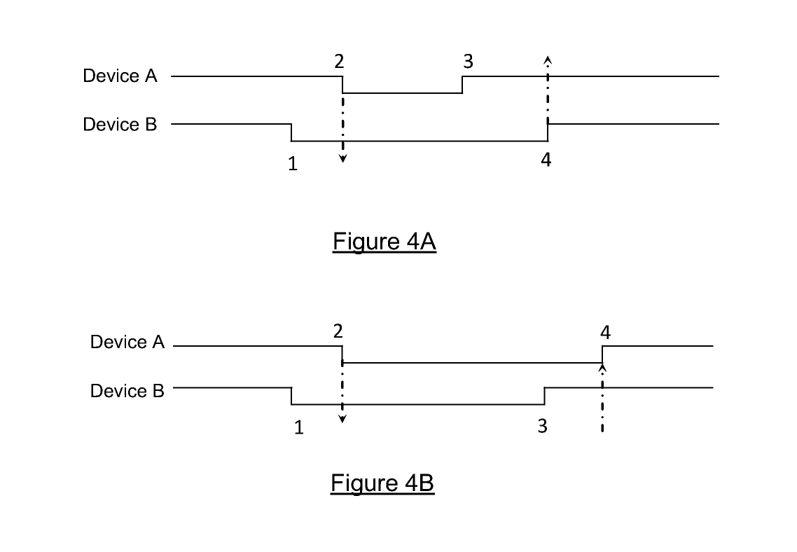

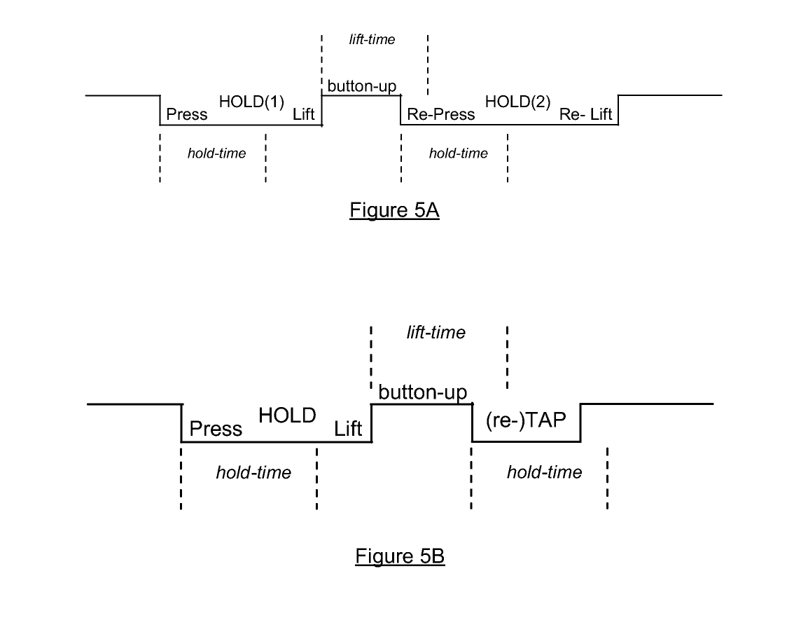

Referring now to FIGS. 4A and 4B, examples of tandem actions between two devices are graphically illustrated whereby the horizontal represents time. As such, in both FIGS. 4A and 4B, Device B is activated first (a button is depressed at point (I)). Then Device A is activated (a button is depressed at point (II)) so that at that point, both devices are activated with the event at point (II) creating the tandem action. The two examples differ with the graph of FIG. 4A showing that Device A is deactivated (the button that was depressed at point (II) is lifted at point (III)) and then Device B is deactivated (the button that was depressed at point (I) is lifted at point (IV)). The graph of FIG. 4B shows an alternate arrangement of actions, where Device B is deactivated (the button that was depressed at point (I) is lifted at point (III)) and then Device A is deactivated (the button that was depressed at point (II) is lifted at point (IV)) at a point in time afterwards. Some points to note about these tandem actions:
The onset event at point (I) in both FIGS. 4A and 4B usually has an effect of its own. The conditional state that follows the onset event (shown by the step down time portion of the graphs) allows provisional options to be selected, according to subsequent concurrent events.
The tandem event at point (II) in both FIGS. 4A and 4B from Device A (as opposed to another device) is interpreted as a selected option.
The tandem event at point (III) in both FIGS. 4A and 4B is the only possible event from Device A (shown in FIG. 4A), but it need not happen at the time (the alternative is shown in FIG. 4B).
Concluding events at point (IV) in both FIGS. 4A and 4B are interpreted against the options taken in (II) and (III). At this point the tandem action ends. Although no longer ‘concurrent’ (in the sense that there is only one button depressed), since the final event may be affected by preceding events it can be regarded as part of the action. Commencement of the action however does strictly require concurrence (as described above).

Looking more closely at the ‘multiple event’ actions and conditional sequences, these actions introduce another time-dependence. Hold and Tap are differentiated by how long a button is held down (referred to a ‘hold-time’), and the button up time can also be tested to see whether the same button (or indeed, a different one) is re-pressed within a pre-specified duration (for example the ‘lift-time’, whether the same or a different value to the ‘hold-time’).

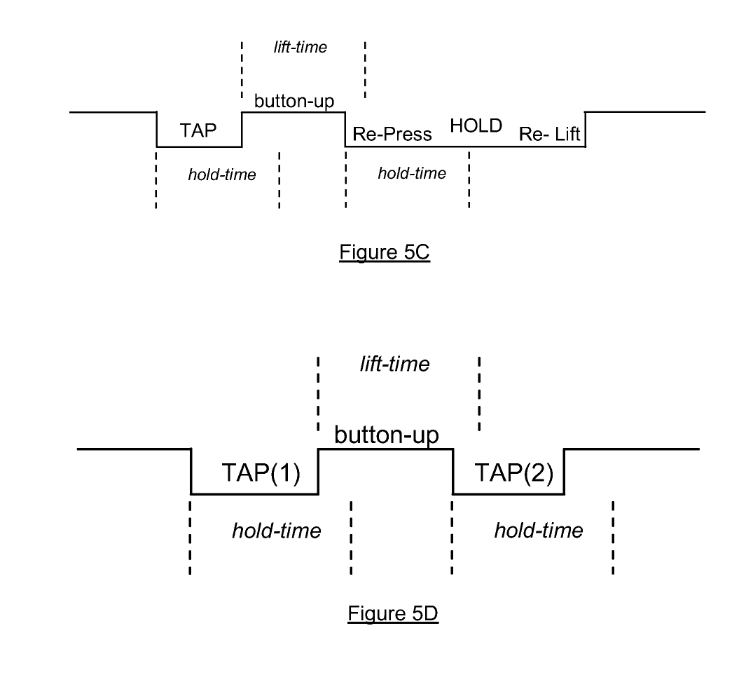

As illustrated in FIGS. 5A to 5D, in the simplest four cases a pair of actions (Hold then Tap, Tap then Tap, Hold then Hold, or Tap then Hold) can be either associated or treated as two separate (normal) actions. More accurately, the second action in each case commences either before the specified button-up interval has elapsed (in which case its events—the press and lift, or ‘tap’—may be assigned alternative functions), or after the specified interval (in which case its events will be treated as those of a normal isolated action).

As an example, say a certain button, button A, is pressed and lifted, to display and clear an on-screen menu. In one instance, the same button is re-pressed within the specified ‘lift-time’, which, for example, opens an Edit Menu function. In another instance, Button A is only re-pressed after the ‘lift-time’ has elapsed, which simply displays the same menu as before. In both cases of this example, the button lift simply clears the screen, no matter what is displayed. This description of two successive Hold (press then lift) actions applies similarly to the other permutations.

The terms, ‘re-press/re-lift’ and ‘re-tap’ refer to the press/lift/tap events in any second action of the pair of actions. The term ‘double-’ is reserved for the ‘double-Hold’ (Hold then Hold) and ‘double-Tap’ (Tap then Tap) actions. This means the ‘double-Hold’ action consists of four successive events: press, lift, re-press, re-lift. A double-Tap is two successive events: tap, re-tap. The other two actions are the Hold then Tap (press, lift, re-tap) and Tap then Hold (tap, re-press, re-lift).

Referring to FIG. 5A, there is graphically shown the timing of taps/holds for a ‘double-Hold’ (Hold then Hold)—a pressed button is lifted and re-pressed (and re-lifted). The re-press occurs within the lift-time interval, so the re-lift is also distinguishable from a simple single lift. Referring to FIG. 5B, there is graphically shown the timing of taps/holds for a Hold then Tap—a pressed button is lifted and ‘re-tapped’ (referring to the second action as a whole). Referring to FIG. 5C, there is graphically shown the timing of taps/holds for a Tap then Hold—a tapped button is re-pressed and re-lifted. Referring to FIG. 5D, there is graphically shown the timing of taps/holds for a ‘double-Tap’ (Tap then Tap)—a tapped button is re-tapped.

These double-actions are somewhat more complicated than a standard mouse double-click. In particular, a mouse is either single-clicked or double-clicked, with different results. The versions for device 10 add events to a normal single-action.

The timing of both the down and up button states allows some other possible ‘multiple event’ action ‘types’ including:
1. Re-pressing/re-tapping any button or device (not just the same button). For example, button tap followed by a mouse re-click, within a specified (lift) time.
2. Triple-Actions, similar to double actions (two successive actions), but where a third action follows the second within the lift-time. It will be appreciated that quadruple actions and more are possible.
3. Concurrent Re-Press/Re-Lift, for example; a button hold is joined by a keyboard key or mouse down press, within a specified time; or a held button is lifted within a specified time of being joined by a key or mouse down press, amongst others. This adds time dependence to tandem actions and uses the order of certain (sequential) events to set unique conditions.
4. Concurrent State Order, for example, distinguishing Shift+Alt from Alt+Shift, even though both keys end up in the down state together.
5. Sequential Event Order, for example, ‘double-tapping’ consisting of tapping a button A followed (quickly) by tapping a button B to set condition[AB], or button B and then button A to set condition[BA].

The above dependencies may be applied to any user variables (pointer location, active screen element, option values or selection etc) in various ways and combinations to set unique conditions and thereby carry out what is referred to herein as a combination action. For example, joining one state (say, a button hold) with another (and in that order), while the pointer is within a particular region on screen. It will be appreciated by a person skilled in the art that such combination actions, in terms of actual implementation of such multiple criteria would be subject to user design considerations.

Referring back to FIG. 1, the supplementary software also includes one or more interface applications 101. Interface applications 101 include conventionally installed software programs that supports events from device 10, as well as keyboard 11 and mouse 12. Interface applications 101 have access to the display and other resources of computer 1, the primary functions of which is to allow the user to perform user operations to access, configure, control, affect target elements 20. In embodiments, interface applications 101 also are used to configure the functionality of device 10, the content, appearance and behaviour of the displays, and other user preferences. In the embodiments described herewith, the interface application 101 takes the form of a Menu Manager application which will also be denoted reference numeral 101.

In the described embodiments, device 10 is supported only by application 101. However, in other embodiments, device 10 is supported by other than application 101 and/or other interface applications in addition to application 101.

The unit collectively consisting of application 101, device 10, display 104, and the other supported devices (keyboard 11 and mouse 12), is referred to herein as the Mitten User Interface and denoted by reference 102. Interface 102 comprises a user-interface sub-system (that is, hardware and software elements for mapping or correlating user operations to system and/or application-specific commands etc, or more importantly to their outcomes). The user interface sub-system (for example, of a user application or also roughly of the whole computing device) comprises all the components (physical and virtual) to which the user ‘has access’. This includes, the physical user devices and their controls, the on-screen depictions of objects, events, parameters and values, and the software elements that correlate the users actions to program events and output and to screen depictions, amongst others. The model simplifies these to ‘user input’ (device events), ‘user output’ (display states), and ‘mapping software’ (a ‘three-ended’ coupling that correlates user input, user output and the (purely functional) program elements of the application. The mapping software is highly distributed and entangled within the application (and its container OS), but is still conceptually discrete and is essentially the component that an interface application partly replaces and/or augments, and which, together with any added/augmented/altered devices and display states together constitute an extensional interface (explained further below) as implemented using extension software 21. This description underlies all discussions of extensional interfaces, cascading, and so on.

In other embodiments, this sub-system may be comprised of other (types and/or numbers of) devices, and/or different software functionality, display states, user operations and others.

The main function of application 101 is to correlate certain user operations with program output that specifies (for each particular case) a set of user actions (such as device events, command-line instructions) that would be sufficient to cause a given function or series of functions to be executed or effected if the specified events were generated in an appropriate (or equivalent) way in (or from) the given session context. Put another way, the effective user input that would cause a given result in a target element (for example to open, save, print a document, select a tool or option, execute a function), is specified as output by application 101, in response to some corresponding, but potentially different, set of user interactions via its own interface, that is that of interface 102.

For example, if a particular keystroke of keyboard 12 (for example Enter) causes some result [R] when input to user element [A], (for example, the insertion of a carriage-return in a text document), then application 101 can be configured to specify [“Enter”] as its program output, for some other user action (for example the keystroke Esc, or a button press on device 10, or on any other user operation).

Thus, an arbitrary set of user operations (in application 101) is mapped (via its program) to another set that is contrived to be identical, or equivalent, to the input required or sufficient to bring about a given result in some other designated user element on the system.

User operations denote a given procedure of user interactions, including device events and associated display states, necessary or sufficient to produce a given result in or from a given context (see session context). That is, what the user does and sees are together constitutive of a user operation.

User actions refer to the physical movements of the user and/or the devices. Device events refer to the corresponding software events and states that are registered by the OS, amongst others.

User commands refer to the results, in a given context, of the user's actions (or corresponding device events). For example, the press ‘Enter’ action, or the Enter key event, can result in any one of the following actions, depending on the context: ‘OK’, execute, follow link, open selected file, or ‘carriage-return’ command.

Program output and program input refer to non-user throughput of applications. User input is taken to consist solely of device events, user output refers to ‘representational’ display states (as opposed to displayed program output such as video and text). Representational display states—for example wherever the screen depicts a software parameter as a button or slider, or a file as an icon or label, an application as a ‘window’, a directory as a ‘cartoon of a cardboard folder’, amongst others. In a G.U.I. a huge amount of screen activity tends to be representational (interface-based), as opposed to real, or final, output such as video, photos (actual photos, not for example thumbnails that use a photo image as an icon to represent a file, even if a file of a photo etc), music (but not musical ring tones that represent the message ‘incoming call’, or ‘alert beeps’ etc), email and document text (that is, real content as opposed to button text labels, numerical parameter values etc). There are in fact display states that are both content and representation (for example, hyperlinked text in a Web document, which can be read as content and clicked as an on screen button). The highly distributed, sometimes ambiguous, nature of display states does not eliminate the important conceptual distinction. It is further noted that ‘display’ and ‘display state’ includes all forms of sensory output device—including screens, speakers, and tactile virtual reality (VR) suits. Similarly, ‘user input’ (devices and events) includes all physical user input devices and data types (for example a microphone) and these in turn may input real content (for example a recorded interview) or representational events (for example command words for voice recognition, ‘Open’, ‘Exit’, ‘Next’, etc). More obviously, keyboard 11 can either type content, or serve as a set of command buttons, (for example pressing the Enter key of keyboard 11 may place a carriage return (content) or ‘represent’ the software command ‘Run File’ etc).

Extension software 21 is a background software process that runs continuously by the processor. Software 21 is logically external to application 101 and enables the program output of application 101 (the results of user operations of interface 102) to be coherently applied as program input to other user software elements, such as target elements 20. Given only one program can be in the foreground at any one time, software 21 must switch the focus as required between application 101 and the session, in response to defined or configurable triggering (and exit) conditions, and handling specified output of application 101 (and returning application 101 to the idle state), all of which will be explained in further detail below.

The unit consisting of interface 102 and software 21, is referred to herein as an Extensional Interface 103 (since it effectively extends, complements, augments the user interfaces in relation to their effect target applications or elements). In other embodiments, interface 102 itself takes other forms but software 21 is largely defined in terms of its essential functions, those functions that are required to implement an extensional interface. As such, the software 21 can support alternative embodiments of interface 102 other that what is described herein, and even configurable in a general-purpose version that supports optional such interfaces that can be implemented not only on the same system but also during the same session.

The primary functions or capabilities of software 21 include, amongst others:
To detect various user and system events and to keep an updated log file or buffer of data that constitutes a description of the ongoing session context.
To detect events from device 10 and respond by (for example) calling, opening, or running application 101 as the foreground element.
To detect events from application 101 and respond by (for example) exiting, closing, deactivating or otherwise moving application 101 to the background.
To access and read data written by application 101 to a shared memory buffer or file.
To generate events that will be interpreted by the OS and/or foreground element as identical or equivalent to those that would normally cause them to perform given user functions.

The action of software 21 exploits (what is referred to as) a cascade, in which the program output of the application 101, mapped from user input operations, is applied to the program input of a second (target) application, and is contrived to be of such a form as to cause the intended output in target elements 20.

A given user command (or series of commands) may not be unambiguously associable with a particular target element 20. That is, commands such as ‘Save File’ are context sensitive as to which file or document will be saved. Often, one element (or executive level of software) is instructed to perform an operation on one or more other elements. That an initial command in some cases will set in motion a sequence that causes the first element to open a second element, such that subsequence commands cause the second element to affect a third and so. There is potentially no need for the current element 20 and/or sub-elements (for example the selected object in the active window of the foreground application) to be even be affected, for example where the initial command in a sequence simply exits the current object and proceeds to act upon some other. So firstly, the ultimate effect or effects of a series of user input events (such as keystrokes) is critically dependent on the circumstances in which the sequence is commenced (so pressing ‘Ctrl-S’ on keyboard 11 will only save a particular file if the keystrokes are executed when the relevant document is open, and is the foreground document in an application that itself is the foreground active window). Secondly, the ultimate target or affected element may not be the one in which a given series of commands is commenced because many commands have the effect of navigating to, or selecting, the ultimate target element.

The minimal inclusive formulation of a ‘user command’ (or sequence of commands) is simply a specification of the events required in a given context in order to bring about a desired result in that (or some other) context. A given sequence of events may produce different outcomes depending on the context in which it is executed, (or from which it is commenced since one or more of the command events may have the effect of changing the context).

For the purposes of description, session context can be taken to mean ‘whatever information is required’ to enable application 101 to properly formulate its output for a given intended result. The session context may be defined in terms of the hierarchy of current elements and sub-elements (for example, a current selected object of a current open document of current foreground application 101). This describes the prevailing state of affairs that may affect the outcome of certain user commands, where the relevant context may be different for different commands, and may or not include every (or any) of the sub-elements specified. For example, to save an MS Word document, the relevant context is that the document to be saved is open and current. Conversely, to open an MS Word document can be taken without reference to document that might be open, or current, if any. Since there is no way of knowing in advance which commands the user might choose to execute from interface 101, application 101 requires the most complete description of the session context available, and to contingently determine the relevance for any given user operation. In all cases, however, the context may be associated with a particular user application, and where appropriate with one or zero currently open files, documents or windows. Finally, one (or zero) objects, fields or other elements will necessarily have the current focus. The session context may be minimally described by these three terms, although some situations may require more information, for example, where a user operation has been commenced but not yet completed, such as opening a menu or dialog.

User applications include the desktop (OS ‘shell’ application) and ancillary components like the taskbar, command-line prompt, and global functions generally, since all of these involve user operations (that is, on adjustable and/or accessible elements). These ‘desktop’ application elements are therefore distinct from the OS itself, even though a integral provision of it.

The nominal target of a given user operation is just the relevant session context in which the commands and events, amongst others, are commenced. It is noted that the execution of the specified events commences from the appropriate context, so the correct specification of the events is subject to the context in which they are to be commenced. That is, information about the context is used by the relevant program (application 101) in correctly formulating the events required for a given outcome.

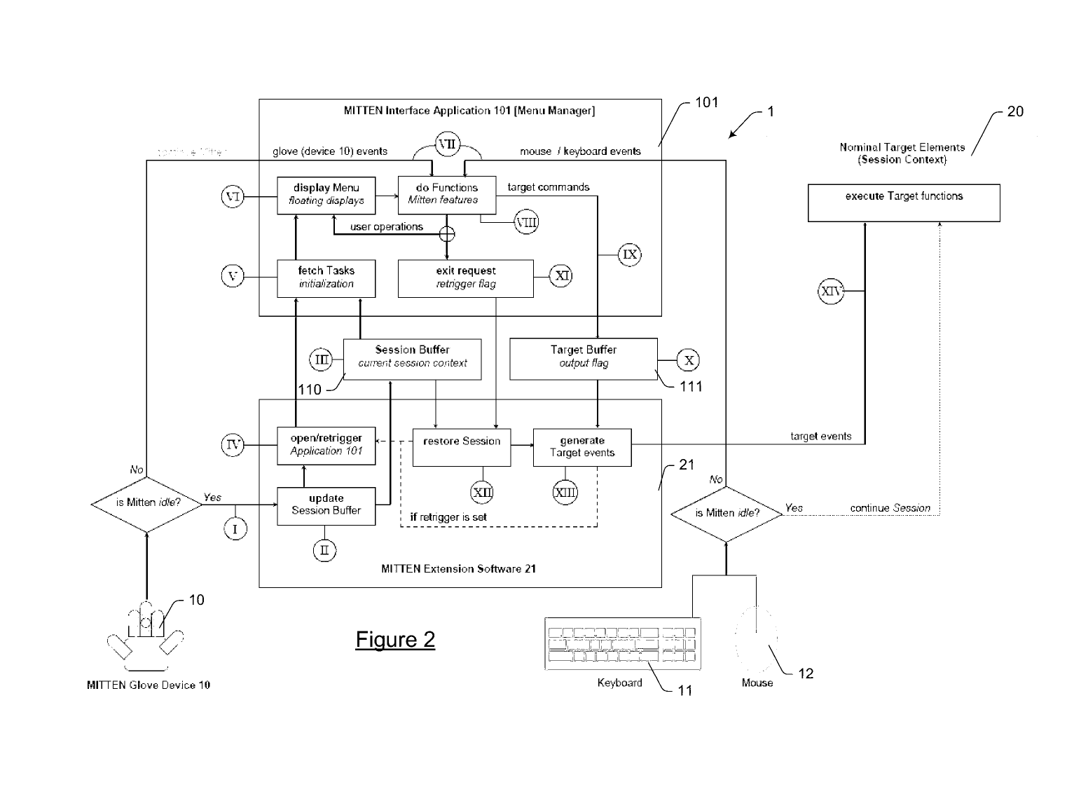

Referring now to FIG. 2, the sequence of events for a typical operation of interface 103 commences from an initial state in which interface 102 is said to be idle, and software 21 is said to be quiescent. During the idle state, the following conditions pertain: application 101 is not the current foreground element, although it may still be running (that is, active or open), and some or all of the display elements of application 101 may be visible (and/or ‘on top’ of other applications). All of the buttons of device 10 will generally be in the ‘up state’, (but if not then any press event ends the idle condition).

Software 21 runs continuously in the background, either a) in its quiescent state, monitoring system and/or user events and maintaining one or more logs or memory buffers of various conditions prior to activating application 101, or b) performing operations that directly affect the session, immediately upon returning interface 102 to idle (see step (X) to (XIII) of FIG. 2, explained in detail below) and prior to resuming its own quiescent activities.

In FIG. 2, the events (and/or elements) are numbered (I) to (XIII) and are explained as follows:
(I) Device 10 Event (Triggering Conditions)—while interface 102 is idle, and software 101 is quiescent, an event from device 10 is generated by the user (for example, a button on device 10 is pressed). Software 21 is configured to detect the occurrence of any context-dependent event defined as a triggering condition, that is, a defined triggering event in or for a certain context or triggering state. In the example of FIG. 2, any button press (down) event from device 10 in any situation while interface 102 is idle, is a triggering condition, although there may be others.
(II) Update Session Buffer—software 21 responds by updating a session buffer 110 (also labelled (III) in FIG. 2) with relevant data on the current conditions, including, the triggering event itself (in this case, the particular button of device 10 that was pressed), and the session context (the prevailing state of the session at the time of the triggering event). The content of session buffer 110 is subsequently made available to application 101. The session context is expressed as the current hierarchy of foreground, active, focussed and other elements, sub-elements amongst others (for example, the currently focussed object, if any, and/or the currently open document, if any, in the current foreground application, if any, and so on). The session context is not the same thing as the triggering state (explained below), although their descriptions may be identical.
(III) Session Buffer 110—this is the physical component described as a ‘shared memory resource’ that is written to by software 21 and subsequently read by application 101. (The other buffer in FIG. 2—a Target Buffer 111—is also shared but is written to by application 101 and read by software 21).
(IV) Activation of Application 101 (labelled ‘call/open application 101’ in FIG. 2)—software 21 calls (or opens, runs, activates) application 101, making it the foreground application, with control of the display, and accessible to the supported user devices (device 10, keyboard 11 and mouse 12). This also moves the previously active foreground application (if one was present) to the background.
(V) Interface 102 Initialisation—application 101 reads the contents of session buffer 110 and accordingly sets the task assignment map (the glove configuration, explained further below) and any other parameter values, either defaults or as previously defined by the user, for the context in question. (‘Setting the task assignment map’ and/or ‘parameters’ may, for example, involve updating a table or registry with the user's previously saved button task assignments along with other options, or the default values, corresponding to the particular context identified in the session buffer. This would then be used to fetch or construct the various displayed menus and other elements in the course of the following activities).
(VI) Interface 102 Response—typically, application 101 will then perform some action (for example display a menu on screen, or execute a command) based on the particular button pressed (the triggering event, also fetched from session buffer 110), and the currently set task assignment map, which contains the complete list of button menus, their constituent items, behaviour preferences, amongst others. It is noted that interface 102 is now operational; all hardware and software elements (application 101, display 104, device 10, keyboard 11, and mouse 12) are configured and active, and the user can see the results of their initiating action.
(VII) Supported Device Events—once activated, configured and operational, application 101 responds to events from all three supported user devices (device 10, keyboard 11, mouse 12), including certain novel types of interactions and display control method, amongst others. These user interactions constitute the physical aspect of interface 102. It will be appreciated that other embodiments could support other types and/or numbers of devices.
(VIII) Interface 102 User Operations—all functions of application 101 are now accessible via the user interactions of interface 102. These operations include: clear the screen, move or display another menu, create or edit elements and assignments, customise behaviours and preferences, or ‘execute a target command’ for example by clicking a displayed menu item, and others. The minimum activity that can occur is that the button pressed in step (I) is simply lifted, but there is no restriction on what may otherwise ensue.
(IX) Target Commands—certain operations of application 101 (such as, ‘execute target commands’ when a menu item, for example, Save File, Zoom In, amongst others, is clicked) will cause application 101 to write a string of data to target buffer 111, specifying one or more events (actions, commands, amongst others) to be executed ‘outside’ application 101 (that is, in the session), that would be sufficient to effect the nominated actions. It is mentioned that the target commands written to target buffer 11 merely specify the (sequence of one or more) ‘events’ that refer to or correspond to the user actions, (such as keystrokes, mouse-clicks or equivalent and/or command-line instructions), which will be used by software 21 to generate real system events, in a similar way, for example, to a macro player. The specified (and subsequently generated) events may use relative or absolute addressing, for example, Open[thisfile], or Open[filepathname] and the like. Additionally, the target events may be prefaced or commenced with an instruction that sets the session to a known or standardized state or location (such as the desktop) before execution of the rest of the string.
(X) Target Buffer 111/Output Flag—like session buffer 110, target buffer 111 is a shared memory resource, but in this case, the buffer is written to by application 101, and read by software 21. On completion of each write operation to target buffer 111, application 101 also sets an output flag, signifying that target buffer 111 contains output data to be handled by software 21. Application 101 may also append further data to the contents of target buffer 111 in one or more subsequent write operations, and again set the output request flag each time (that is, it will remain set), or it may unset (or clear) the output flag without necessarily deleting target buffer 111 if the data is no longer required and is to be ignored (for example, if the user cancels or aborts a target command after the data has been written to the target buffer). The output flag may be set, unset, and reset, as required, depending on whether the data is to be read, ignored, or re-read (for example, where a command is to be re-executed), and just indicates the momentary status of the data in the target buffer. In other embodiments, there is more than one target buffer, each with an associated output flag. The register or buffer to which this flag and any others, for example the retrigger flag that will be explained further below, are written, constitute another shared memory resource, available to both application 101 and software 21.
(XI) Exit Request/Retrigger Flag/Retrigger Conditions—when or if application 101 encounters a state signifying an exit condition, application 101 generates an exit request which is detected by software 21. An exit condition is typically encountered when either: a) the user has completed (without cancelling, undoing or aborting) an execute target command operation and the specified data has been written to target buffer 111, as in step (IX); or b) the user otherwise concludes or terminates any operation in a way that implicitly or explicitly signifies a return to the session (that is, whether or not step (IX) was completed); or c) an operation of application 101 in progress needs to access the session, for example where the actions of the user in the session (mouse clicks, keyboard strokes) are to be recorded for later use by application 101 as target output, requiring an exit to the session where the capture of events is handled by software 21 and passed back to application 101 when done. Whenever application 101 is ready to be exited, the exit request is generated, and software 21 responds by proceeding to step (XII) below. In many instances, application 101 will need to be reinstated (retriggered) under conditions that differ from those specified in (I). For example, whenever the user executes a target command in application 101 (such as by clicking an item in a held menu), application 101 will set a retrigger flag, prior to generating an exit request. After software 21 has completed the previous steps and the target command (or other instruction) has been processed, application 101 is automatically (without user intervention) returned from idle to its former state (for example with the menu still displayed in the same location) in case the user decides to execute a further command from the same open menu. This process may be repeated a number of times until the user explicitly exits application 101 and returns to the session (for example by lifting the held task button to close the menu). In this instance, the retrigger flag is not set (or it is unset), the exit request is generated (returning application 101 to the idle state) and software 21 again awaits the triggering conditions specified in (I). In other circumstances, application 101 is re-triggered, not automatically, but in response to an explicit but alternate set of retrigger conditions. For example, when a capture events function of application 101 is initiated, as in c) above, application 101 exits to the session where the actions of the user are detected and stored by software 21 until the user terminates the capture process, either with an ‘OK’ action (that is, stop/save captured events and retrigger application 101) if and only if button 46 is pressed, or with a ‘Cancel’ action (that is, discard capture events and retrigger application 101) if and only if button 45 is pressed, or by aborting the function altogether and simply returning to the session (that is, no retrigger) if some other event occurs (for example, the mouse pointer is dragged to a screen edge), or indeed by pressing a task button (which is the normal triggering condition for opening application 101). Upon the retriggering of application 101, any events or data logged by software 21 is available to application 101 in a manner similar to that in which session buffer 110 is available after a normal activation from idle. That is, application 101 retriggers if A or B occurs, unless C occurs (in which case, abort capture process and remain in the session without retriggering application 101), or unless D occurs (that is, the normal trigger conditions (I), in which case application 101 is to be opened in the normal way). If the capture process is on the retriggering of application 101, any events or data logged by software 21 during the capture process are available to application 101 (in a similar way to that of the session data during a normal activation from idle). Retrigger conditions are specified by application 101 (by writing to or referencing a suitable memory buffer) at or prior to setting the retrigger flag. The specification of the retrigger conditions is retrieved by software 21 (from the memory buffer) whenever the retrigger flag is set and an exit request occurs. If no retrigger is required, as in a) and b) above, application 101 simply generates an unconditional exit request (with the retrigger flag unset). If the output flag is also unset, and so there are no target events to process, then steps (IX), most of (XII), and (XIII), are omitted.
(XII) Restore Session—upon detection of an exit request, software 21 deactivates application 101, either by sending it to the background, or in some other fashion that will restore the session to its initial state. This action replaces application 101 as the foreground application with the state described in the session context, and returns interface 102 to the idle state.
(XIII) Target Events—software 21 checks the output flag and if it is set, software 21 un-sets it, reads target buffer 111 and generates the specified target events to the operating system in a form that is equivalent to, or indistinguishable from, those normally generated either by the user devices (or an equivalently executive level of software) and obtains the same results. If the output flag is not set, this step is omitted. If the retrigger flag is set (XI), then software 21 (either immediately, or after processing target buffer 111) will await the occurrence of either the re-triggering conditions (the specification of which is retrieved from a relevant buffer) or a condition that cancels the retrigger flag and reinstates the normal triggering conditions (I).
(XIV) Target Elements—the generated target events will be interpreted in the context of the restored session, or nominal target. By default, the nominal target will be the same as the session context since exiting application 101 will restore the system to its previous state. An optional method involves application 101 preceding its specified target output events (that is, the block of data written to the target buffer) either with an absolute command that reliably sets the context to a standardized nominal target, for example, to the desktop, or else initializes the target application in some fashion such that the mouse pointer is clicked (in some fashion) to ready the target application for commands, for example by clearing any application drop-down menus from screen, or closing any dialogs (with ‘cancel’). These are part of the functioning of application 101 and do not otherwise affect the global or session behaviour of interface 103.

Since software 21 (and application 101) are returned to the same quiescent or idle condition as at, or prior to step (I), whether or not the ‘retrigger’ loop is followed in step (X), the steps described form the basis for all definable ‘Mitten’ activities.

General features of extensional interface 103 include the use of what is referred to as ‘cascaded’ interfaces. The general method used by interface 103 (as described above) is, first to use one set of user operations to produce program output from interface application 101. The output of this is contrived to be, or to specify, events of a suitable form (referred to herein as sub-process A), and second, to make those specified events available in a manner, and context, that brings about the expected results in the intended target elements (referred to herein as sub-process B).

Sub-processes A and B are handled, respectively, by interface 102 (which is reducible to a user application that produces a specification of target events in response to performed user operations), and software 21, which effectively ‘serialises’ the conceptual connection of the interface and target applications. Since only one ‘user application’ can be in the foreground at a given instant, the output of interface 102 is read or retrieved by software 21 and only made available (or output) at such time as the appropriate (destination) element is in the foreground (that is, once the appropriate session context is restored).

Applying the output of one application as input to some other (destination) element is referred to as a ‘cascade’, the effective result being that arbitrary, independently determined user operations in the first application can be made to produce outcomes that would otherwise require a particular user operation or one of a particular set of user operations, determined in each case by the second application. As mentioned, the so-called ‘second application’ is in practise not a particular application but rather any set of user elements (again, generally referred to as a ‘context’; any navigable place or circumstance in the session qualifies as a ‘context’), and a given output may produce effects across multiple such elements (that is, a given output may include navigation between elements as well as effects upon the element itself).

Another general feature of extensional interface 103 is what is referred to as ‘extended functionality’. Since interface 103 increases the number and type of user operations that can (in principle) be employed to optionally produce a given outcome in a given user application, the arrangement is referred to as an extensional interface.

Another general feature of extensional interface 103 is what is referred to as ‘virtual operation’. Interface 103 appears to allow a user to directly manipulate a given (target) application, using an optional, potentially extended, yet essentially arbitrary set of user operations. In actual fact, the target application is shielded from the extensional component, which generates the expected or required input events to the target application and the apparent presentation of display states in response to the actions of the user.

Another general feature of extensional interface 103 is what is referred to as ‘universality’. An extensional interface of this type is said to be universal, in the following related senses:
The extensionality is session-wide in that the user operations defined by interface 103 are not restricted to use in particular applications (or as defined by those applications) but can be used with any and all target elements that happen to be running on the system. It is noted that this universality is ‘contrived’ in the sense that the extensional interface must be pre-configured to output the appropriate events correctly for each target.
The extensionality is context-consistent. This means that its user operations are compatible with, and behave consistently, across any target elements. For example, even applications that differ in the user operations required for a given task, for example, will respond to the same user operation performed in the extensional interface.
The extensionality is support-independent, which is similar to the operational independence of being context-consistent, but with respect to the hardware (and/or the hardware events). The user actions may be delivered via any number or type of user devices, without requiring support from individual target elements. Not only do targets respond consistently to a given type of user operation, but the types of operation are not restricted by required target support.

These above three senses are aspects of the fact that the internal activities of interface 103 are isolated from, and invisible to, the session. Only the program output needs to be compatible with a target element, and this is a function of the extensional interface application itself, which correlates its user operations (the device events and display states employed) to the resultant output that the target element sees.

The two principle components of an extensional interface and their implementation may be described generically, and embodied in different forms:
1. The first component is a user interface sub-system, consisting of a user application (such as interface application 101), one or more supported user input devices (such as device 10), and a display or other user output hardware (such as display 104). It is noted that the presentation of events and states to the user (via the display) as well as the actions they perform, are part of what constitutes ‘user operations’, and hence a user interface. It is further noted that the input (devices) and output (display) hardware can be reduced to software terms by referring to the corresponding device events and display states. The user (interface) application's program correlates particular (input) user operations with program output that specifies a corresponding set of user events for obtaining a given outcome in a given context in some specified target application (such as target element 20). The possible types of user operations depend on the available device events supported (as generated by the physical devices), but provided its output is of the appropriate form, any sort of internal behaviour and features are permissible. The application component is designated an interface application, with the entire user interface subsystem (of which various embodiments are possible) constituting an extensional interface.
2. The second component is the extension software (such as software 21), which integrates the extensional interface and target applications, effectively ‘cascading’ the output of the former to the input of the latter. This process is necessarily (or logically) external and somewhat more constrained by its required system-level functions, which include:
   Running continuously in the background.
   Being configured, or configurable, to respond to defined triggering conditions.
   Being able to detect and log certain user and system events.
   Maintaining one or more memory buffers shared with the interface application.
   Being capable of generating certain system and user events (target events).

The term, extensional interface, strictly applies to the functional combination of the two components as described in embodiments herein. Although in alternate embodiments, or descriptions in the one embodiment, it is applied to the first component where appropriately implemented by or under the second since an ‘extensional interface’ is implemented by virtue of the extension software, there is a sense in which the latter is, and must always be present, even though not itself part of the extensional interface per se (which may take different forms in different embodiments).

The extension software component (in the present embodiments being software 21) may also be extended to support a variety of alternative, or optional, embodiments of extensional user interfaces, for use with common or different target applications running on the same system. This leads to the notion of a general purpose universal extension utility whereby a single extension process could be user-configurable to support a variety of user interfaces, each one enabled under exclusive (user-specified) triggering conditions, and for specified target applications or contexts.

It is noted that a given target application might be controlled by any (or all) of a possible number of installed ‘plug-in’ interfaces, at various times. Conversely a given interface might be used to control any, or all, of the target applications on a system, at the discretion of the user. In such a case, the extension component would itself include a user ‘interface’ for viewing, accessing and configuring the relevant options.

Menu Manager application 101 supports device 10, keyboard 11 and mouse 12 events, and allows the user to create, manage and deploy sets of customisable menus for executing commands in the ‘regular’ session of the user. The use of Menu Manager application 101 compliments the two-handed potential offered by device 10 in conjunction with keyboard 11 and mouse 12.

To display a certain menu of application 101, button 30 (for example) is pressed and held down. This is referred to a ‘held’ menu while button 30 remains pressed. To clear the menu, button 30 is lifted (released). To latch the menu onscreen (that is, for a menu to stay onscreen without holding down button 30) button 30 is tapped. To clear the latched menu, button 30 is re-pressed and lifted. It is noted here that a held menu appears onscreen at or near the mouse pointer location. A latched menu remains onscreen at the location in which it first displayed (that is, at or near the pointer).

To execute an option on a menu, mouse 12 is clicked on the menu item (on a held or latched menu). To abort or cancel a clicked item in a held menu, the (held) button is lifted prior to releasing the mouse. For a latched menu, the abort procedure is to press and hold any button of device 10 while releasing a clicked button of mouse 12. The execute and abort actions above are examples of basic ‘tandem actions’; other intervening events allow menus to be moved, latched, re-configured (edited), re-assigned (for example, swapped/copied to other button), amongst others.

In some embodiments, menu manager application 101 also includes auto-execute items on menus. Such items are executed automatically when lifting a (pressed) task button (such as button 30) on a pre-designated and pre-configured menu item (instead of just clearing the menu from screen). Either a ‘one and only one’ action is selected and the menu is set to auto-execute, or a ‘one or none’ action is set to auto-execute. These are two possible ways of incorporating the ‘auto-execute’ function:
In the first, the action (or item) to be auto-executed is selected or marked (ticked) and the menu is also set to ‘auto-execute’. This allows an action to remain selected even allowing the auto-execute function itself to be independently selected or de-selected.
In the second, simply marking an item sets it to auto-execute, and un-marking it (so that zero items are marked) cancels auto-execute.

Either system would work, although the first method is preferred (despite requiring two settings; the advantage is that the auto function can be ‘globally’ switched on and off as a menu setting, without having to hunt for and unmark a selected item).

When, say, button 30 is pressed (and held), the menu is first displayed and the item to be auto-executed is highlighted (or all other items are hidden/grey). An impending auto-execute may be aborted for example by mouse-clicking anywhere on screen while the task button is held. Otherwise, lifting button 30 executes the item (and clears the menu). Aborting clears the menu without executing the auto-execute item. Alternatively, aborting cancels the execution of the auto-execute item and latches the menu. Commands are generally only executed on a button lift (or mouse/key release), with the abort and/or clear functions always available via a tandem action prior to the button lift/release. These specified actions are just examples and in other embodiments, the actions vary.

An alert is displayed at or near the pointer whenever an action is available for that pointer zone. Also, a menu status bar or field would notify of the optional tandem actions available for the current state.

In preferred embodiments, utility buttons 45 and 46 behave and display the same across all session contexts. Specifically, when pressed, button 45 will “toggle all visible displays” (that is, clear/restore). When tapped, button 45 will “display global library menu”. When button 46 is pressed, the “display task assignment map” will appear on display 104. When tapped, button 46 will “create/acquire new task”. These functions will described in detail further below. In other embodiments, buttons 45 and 46 will behave differently depending on the target application.

With the exception of the press functions of button 45, the utility buttons invoke what is referred to herein as ‘utility mode’. In utility mode, the task buttons are usually assigned a set of alternative (non-task) functions.

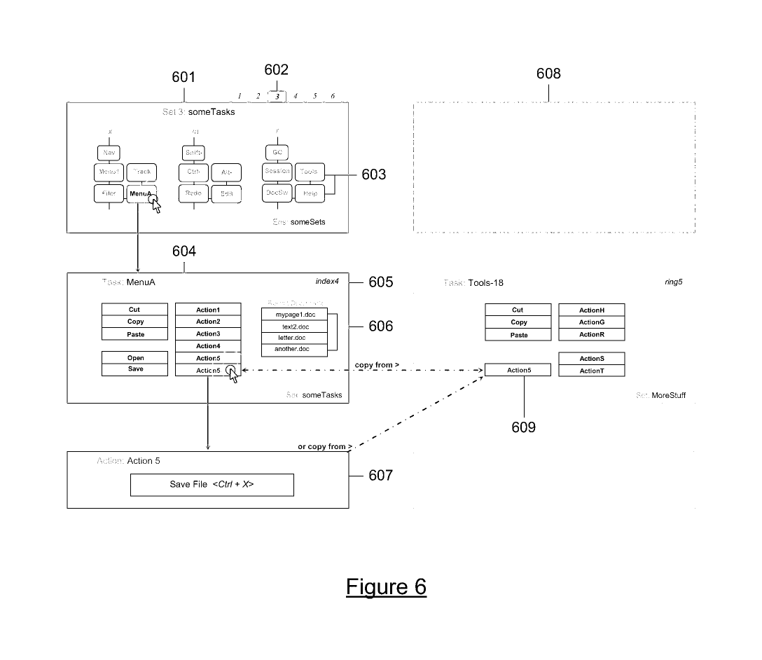

Panel actions, mentioned previously, are a dedicated set of tandem-style actions for viewing, navigating, traversing, comparing, selecting, and assigning (amongst others) ‘mitten user elements’ in exploding/collapsing view panels, as shown in FIGS. 6 to 13. The use of panels and panel actions improves on conventional folder-tree systems, allowing multiple branches and elements to be rapidly manipulated. Mitten user elements include Tasks, Sets, Ensembles, Menus, and Actions, amongst others. Mitten user elements are the various user-configurable (instances of) objects like Tasks (Menus), Sets, Ensembles and Actions (the latter elsewhere called Items or Menu Items to avoid confusion with, for example, Mitten Actions and Button Actions).

The concept of panels refers to elements forming a nested structure of containers and content (sub-elements), as shown in FIGS. 6 to 13. A given panel shows the container (open) and depictions of its content elements (closed). A sub-element can be opened (as a panel), for example, to show its sub-elements. Multiple panels can be displayed and act as source/destinations. Note that each element type only contains sub-elements of a particular kind, and in some cases of a fixed number.

Referring specifically to FIG. 6, the features shown are as follows:
Reference numeral 601 is a task assignment panel map which shows a standardised schematic depiction of a set (of 15 button tasks).
Reference numeral 602 indicates the displayed (and/or active) set as number “3” (of the six available set) within the current ensemble.
Reference numeral 603 indicates the tasks within the current set, specifically the two assigned to buttons 42 and 44 of device 10. It is noted that “x” stands for the buttons of the index finger (that is, buttons 30 to 34), “m” stands for the buttons of the middle finger (that is, buttons 35 to 39) and “r” stands for the buttons of the ring finger (that is, buttons 40 to 44).
Reference numeral 604 shows the opened task (menu display) for the indicated “MenuA” button (for button 34 of device 10) in the displayed set. The title (in this case “MenuA”) is a user designated name (and/or the “filename.tsk”) assigned to this button.
Reference numeral 605 points to the Button ID, in this case “Index4” (meaning index finger button #4, corresponding to button 34) to which the displayed “MenuA” is currently assigned. The Button ID is generally the button assigned this task/menu, and the active set/ensemble name.
Reference numeral 606 indicates sub-element actions within the displayed menu (these actions are part of a Menu Module, to be explained later).
Reference numeral 607 shows the details and keystroke events (of keyboard 11) of the action labelled ‘Save’ from ‘MenuA’. This field can be edited by the user to produce a new or variant action (command string). It is important to note that instances of the term ‘action’ (as in Menu Action) is equivalent to ‘menu item’.
Reference numeral 608 represents a second task assignment panel map (as such another of the six sets of the current ensemble) and its series of views that will be represented similarly to 601, 604 and 607.
Reference numeral 609 shows ‘Action5’ copied from the panel of 604.

Elements can be moved, copied, swapped, re-named and deleted, amongst others, between panels. In this example, ‘Action5’ is copied from ‘MenuA’ in ‘Set 3’ (tilted ‘someTasks’), to the task menu (‘Tools-18’) in another set (titled MoreStuff), either by using mouse 12 to drag and drop from menu-to-menu (604 to 609), or from action-to-menu (607 to 609). Elements can also be re-arranged within their own container.

In the preferred embodiments, menus contain any number of actions (items) but sets always contain fifteen tasks (corresponding to the number of buttons on device 10). As such, the tasks/menus can only be re-arranged (by swapping or overwritten with a copy, but not removed or added).

It is also appreciated that the layout of panels is flexible as Items can be moved and new columns may be added. Menu items are the content sub-elements in a menu for device 10. A menu module is a functional block inserted into a menu, for example ‘Document Switcher’. A ‘menu module’ is proposed menu content type consisting of not just a clickable command or button (such as normally found in menus) but a more functional area or block, in the manner of for example a toobar, or a listing of the currently open documents in the present application (for example, like the list of open documents in the Window menu of MS Word, where clicking one of the document names brings that document to the front). This is what is referred to above as a ‘Document Switcher’ module.

Other possible ‘modules’ include: ‘View Module’ (with zoom, fit to screen, full size, next/previous section/document, show non-printing characters, show/hide toolbars, amongst others), ‘Navigate Module’ (with page Up/page Down, mark location, go to location, scroll vertical, scroll horizontal, amongst others).

Utility operations refer to functions for customising a panel or menu. Such operations include:
Editing the parameters of a single element, or its arrangement of sub-elements.
Assembling: that is, swapping an element's sub-elements using one or more source elements. A source element is, for example, a Set from which Tasks may be copied across to some other ‘destination’ Set. The terms, source and destination, simply denote the direction that sub-elements are being transferred from one container to another. Of course, ‘swapping’ elements implies that each container is both source and destination, but an individual transfer is still from a source to a destination. Note that this also highlights that new Tasks (and Sets etc) will be more likely derived from copies of existing ones, rather than being created from scratch. There is no need to explicitly define items in a menu if they can be copied from an existing menu (and tweaked as necessary).
Assigning: that is, associating software with hardware elements (such as associating tasks to buttons, for example).

The types of operations that are available, the methods used, and the types of elements on which the operations are used will vary depending on context.

Active elements are those directly available, in a given context, via the buttons of device 10 (that is, the set of tasks that could currently be displayed). Current elements are those assigned to device 10, in a given context, even if not directly available on the buttons (that is, sets of the current ensemble). Assigned elements are those which are only current and/or active in other contexts. Elements not presently assigned in any context may be available in the Global Library Menu (if the user has stored them there) or else only in ‘the database’ (on disk). ‘The database’ is a program area of the Menu Manager which not only shows all user files (that is, of Menus/Tasks, Sets, Ensembles etc) on disk drives currently attached to the system, but allows them to be loaded into Panels and ‘opened’ to show their sub-elements (and sub-sub-elements etc where applicable). In addition, the Panels (in the database) can load assigned/current/active elements, as well as those in what is referred to as the Global Clip Library (explained further below). Many of the latter will also be on disk, but the intent here is to source elements from any accessible location and assemble and/or assign them freely. However, if desired source and destination elements are all current, active or in the Library then there is no need to use the database. This feature is not fully specified, but is simply the area where any accessible user element can be found, and manipulated using Panels.

It is noted that all elements are accessible in the database (at the least convenience). Conversely, active elements are maximally accessible but limited in number. It is further noted that required elements may be transferred across contexts using the Global Clip Library, retrieved from the database, and/or made more available by, for example, temporary assignment. The ‘Global Clip Library’ is also a program of the Menu Manager, which can be used to store elements (that is, their names and type—this Set, that Menu etc) for later use. The stored elements can be ‘opened’ (to view or manipulate their sub-elements), assigned directly to device 10, renamed, removed and other such functions. The term ‘Global’ means that the same contents are displayed anywhere in the session (unlike the menus for device 10 which may change from one application to the next). This allows, for example, a currently active set for device 10 to be pasted into the library and then reassigned to device 10 after switching to a different application. Alternatively, elements can be stored to free up room on device 10 without closing them completely, when they would only be accessible on disk (that is, via the database). Newly created actions are automatically placed in the Global Clip Library for testing (in any application) and assigning.

The available utility operations and applicable elements in each case are summarized below:

Active menus (while displayed) may be edited ‘in-situ’, temporarily exiting Task Mode and allowing Utility Mode operations (such as renaming (title and/or items), or re-ordering, removal, or hiding items), assembling of menus (using items from multiple latched menu displays), and re-assigning menus within the current set (equivalent to assembling the current set), swapping the locations of menus between buttons. These operations are available within, or between, active tasks of the active set (only).

The task assignment panel allows operations on any current elements including displaying any or all active and current sets (using a single task assignment map display), editing and assembling sets (using multiple task assignment map displays), and assigning (switching) the active set (re-assign active set from the current ensemble). These operations are used for all active and current (context specific) elements.

The global clip library in relation to assigned and library elements includes all operations using the global user library, such as, displaying library elements and editing, assembling and assigning library elements.

Using database panels in relation to all elements includes operations on any elements, including:
Loading and displaying elements currently on disk.
Displaying any assigned, current or active elements (that is, the task assignment map) or from the global clip library (even if such elements are also on disk).
Using multiple source and destination panels for navigating, comparing, selecting, editing, saving, and assembling any of the above elements from or to any others.
Assigning elements from any source (or assembled in the Database panels) to the current Ensemble or active Set.

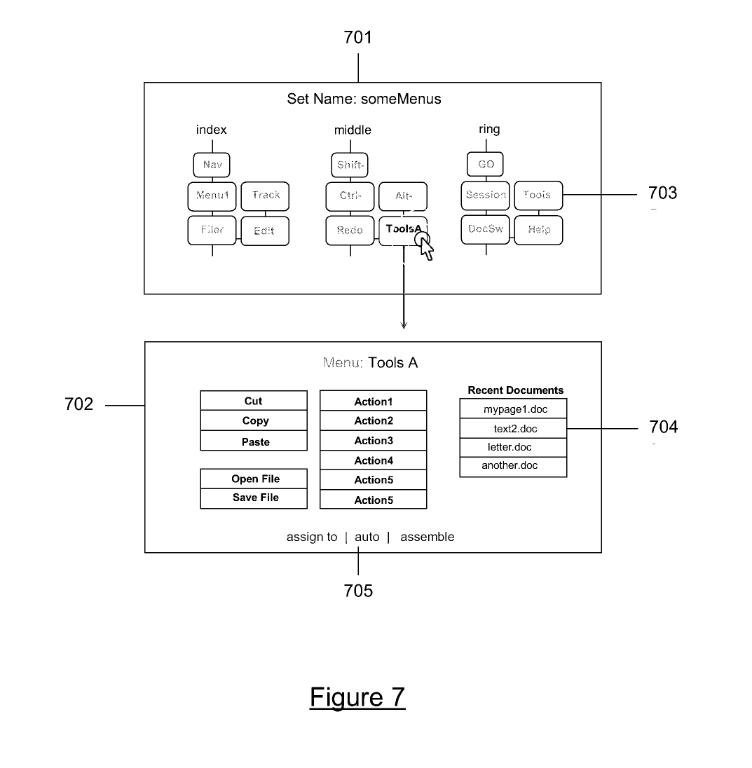

Referring to FIG. 7, there is illustrated a panel-style display where:
Reference numeral 701 is a container, set and panel. An element is a container, the contents of which are sub-elements of the appropriate kind.
Reference numeral 702 is a container showing an open task menu for the “Tools A” button.
Reference numeral 703 indicates another sub-element (task) having the content of “Tools”.
Reference numeral 704 represents sub-element actions within the displayed menu, in this case recent documents.
Reference numeral 705 points to various clickable commands and options. For example: 1. ‘Assign to” (when clicked) will re-assign ‘this’ menu to the ‘next pressed task button’ (and re-assign the pressed button's menu to ‘this button’—that is, swap menus); 2. ‘Auto’ would enable ‘auto-executing’ for this menu (of a pre-selected item); 3. ‘Assemble’ will offer an alternate route to the Task Assignment Map, or invoke utility mode etc; 4. Other such menu options might include ‘Show Only Marked Items/Show All’ (or Hide Marked Items/Show All); 5. Tabs to switch the active set to one of the other sets in the current Ensemble, thus changing the displayed menu to the one in the corresponding (button) location in the new Set, and so forth. These type of commands all allow re-assignments of various sorts from within any displayed menu.

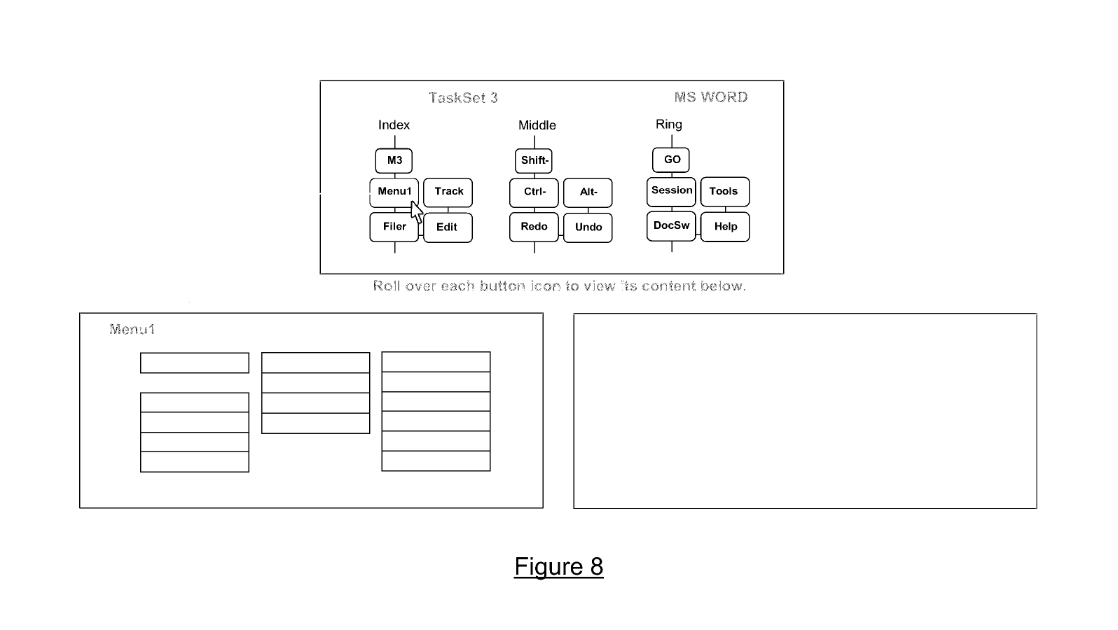

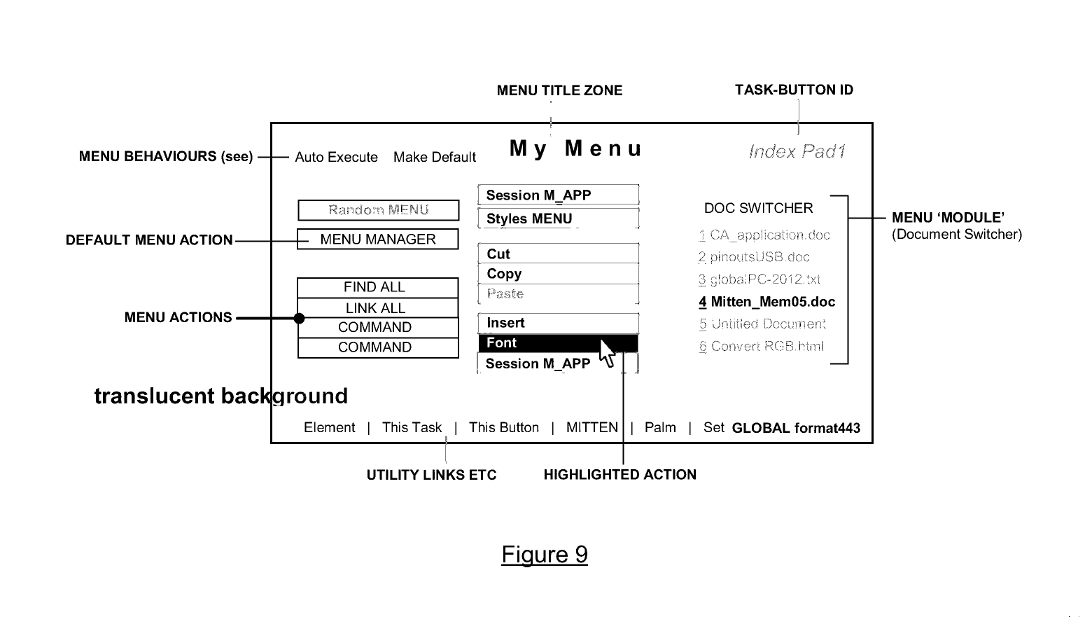

FIG. 8 shows multiple panels in use where a user can move straight from here into more detailed editing views, by adding more panels for example, or simply lift the button 46 to clear the screen. This view of sets, and the methods for viewing and manipulating their components, forms the basis of the assemble and assign operations.

Menus can be assembled from one or more actions, and be assigned as button tasks. A menu is essentially a type of application for device 10 that runs within the main shell of application 101, and includes many more features and functionality than a conventional drop down menu. Any number of items can be included in a menu; similarly, a given item can be included in any number of menus (having more items in a single menu is clearly better than having just a couple of items in several menus, but the user can customise menus as desired).

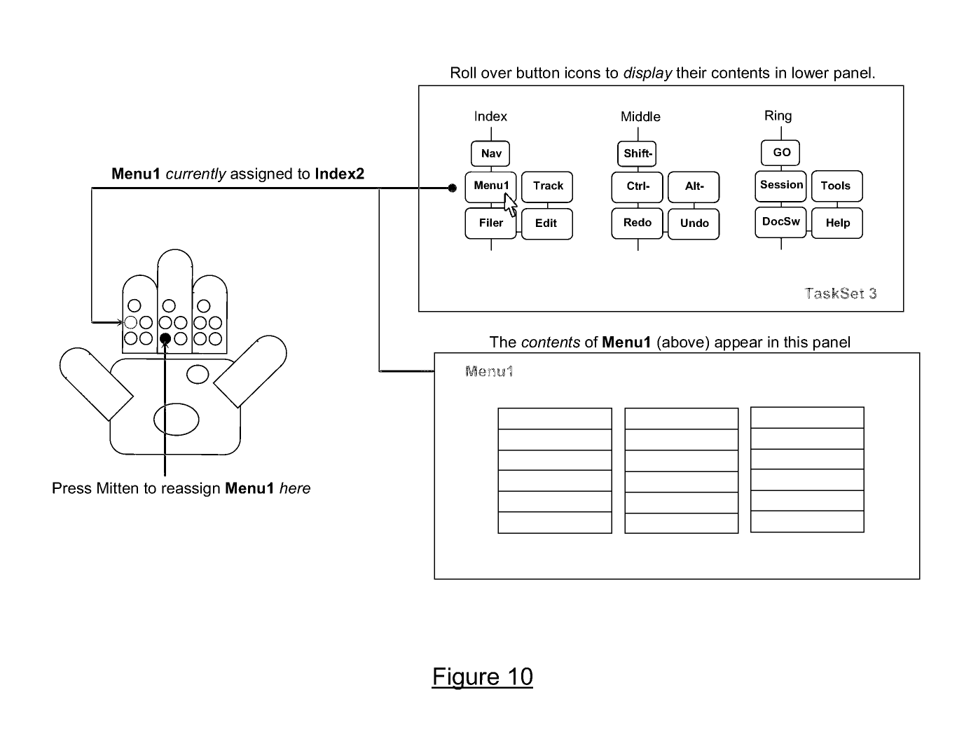

FIG. 9 shows a menu specific to device 10. The display features of the menu include:
Menu Title—a user designated name (or otherwise default to the filename, that is, “filename.tsk”).
Button ID (upper right of the menu)—the button assigned this menu (in this case “Index Pad 1” which is button 30.
Menu Items—the actions, objects, commands, tools and other click-able links in the menu. Each item also includes one or more checkboxes to ‘mark’ the item for various purposes, and an optional method for marking (one and only one) item as, for example, the auto-execute default.
Menu Module—a special type of functional block inserted into a menu, for example, ‘Document Switcher’ shown here.
Utility Links—links to utility functions, for example, for in-situ editing, reassignment, amongst others. For example, when clicked:
(a) ‘Element’ opens a display that tracks where instances of this Menu are included in other Sets (and Ensembles) with an option to select Global (apply Menu edits/changes to all instances), Local (applied only to this instance, and index the title), or Selected (select instances to apply changes, and index their titles). In this embodiment, the default would be ‘Local’ (the tracking feature must critically accommodate all element types).
(b) ‘This Task’ re-assigns (for example, copy, swap) ‘this’ displayed menu to the next pressed task button. Similarly, ‘This Button’ re-assigns to ‘this’ button the menu currently active on the next pressed task button. Thus active tasks/menus may be freely re-assigned, using the buttons to indicate the assignment destinations or sources.
(c) ‘MITTEN’ opens a global options page.
(d) ‘Palm’ opens the Task Assignment Map (for example, positioned above or near the displayed menu).
(e) ‘Set’ allows the (named) active set to be switched to another in the current ensemble. A ‘Tabs’ link, not shown, could also enable this feature.
Other possible options for links to utility functions include: Show/Hide Marked Items, and Sort/Sift Items, for example by Global or Local, by ThisApp or AllApps (that is, application specific items or general OS commands).
A user-editable field or text-area block which, in other embodiments, is for example located at/across the lower area of menu of FIG. 9, and expandable to fit contents, but is not shown in embodiments of the Figures. Such a field contains the details of the selected or highlighted (or ‘marked’) menu item. These details include the keystrokes and other actions or events that make up the command or item. User can type or perform key and mouse actions to replace (or edit) those displayed in the field.

Menus always have one default item (which is user-designable, unless there is only one item), which displays at the pointer of mouse 12. The display features of the default menu items include:
Make Default—menu option control for allocating the default item.
Use Default—if checked, the default item will automatically execute when the menu clears (on lift of the relevant button).

Menus that contain a single item behave the same as other menus, but take up less screen space. It is noted that even if auto-executed (that is, use default is checked), the user still sees the display prior to lifting the button.

Mouse hot zones (also referred to herein as ‘pointer zones’ or ‘mouse zones’) are regions that register mouse-clicks in tandem actions. These include, amongst others:
Top menu-title bar zone (title zone), for example to enable renaming, or to latch the menu on-screen.
Background menu zone (menu zone), for example to enable renaming, or to latch the menu on-screen.
Screen outside menu zone (screen zone) for example, to abort a pressed option prior to lifting.

It will be appreciated that in other embodiments, other menu features and options are possible in addition to what is described herein.

Menus can also be configured as ‘single command shortcuts’, for maximum efficiency, simply by electing one item as the default (even if the menu contains other items), and enabling Use Default item, which simply causes the selected default to be executed when the pressed task button is lifted. Clicking the mouse (anywhere) prior to lifting the pressed button provides an abort function if necessary for the auto-execution, and is one of the operational conventions of device 10 in interface 103.

In embodiments, such as for an optional mode of the Menu Manager Application, the buttons of device 10 are used to perform various types of ‘non-menu’ functions, such as:
A copy and paste function (and/or cut and paste), where pressing a preselected (task) button causes the currently selected object or text block (amongst others) to be copied (or cut) to the system clipboard, whilst subsequently lifting the button, after navigating (via mouse and/or keyboard) to the intended destination, causes the contents of the clipboard to be pasted at the new location (for example, at the current text cursor position, or window as normally the case for clipboard functions).
A zoom and/or view function where, for example, pressing a preselected (task) button causes the view to be magnified by a preset amount (for example ‘zoom in’ ×2), and lifting the button restores the previous view (‘zoom out’ ×2). In other embodiments, pressing and lifting a button will toggles the layout of the current page, for example the location and/or visibility of toolbars or other objects, between two configurations, or even toggle between different documents, pages, windows, or applications, amongst others.
A compare function, where pressing and lifting a button, switches the view between a currently edited but unsaved version of a user document (or other type of user configurable entity) and the saved or previous version of that document.
A tool toggle function in which pressing and lifting a button alternately selects, and restores, the current tool or cursor function.

Other such functions for the press and lift (or tap) actions of the buttons can be envisioned, and/or alternative methods of those described, any of which may further exploit tandem actions. For example, in the zoom function, various different buttons could each be set to different zoom levels (either positive or negative percentages for zoom-in and zoom-out) and when lifted, the same default view is restored (for example to 100% or some other default). Or alternatively, the mouse can be clicked in either of two predefined zones, that appear when a certain task button is pressed, to respectively increase or decrease the zoom while that button is held down, and whereby the original view is restored when the button is lifted. Another alternative embodiment includes returning the view to the default (such as 100%) if another tandem event occurs. Alternatively, a series of tandem events (for example, mouse clicks or rolls) while either one of two zoom buttons is held down—one for zoom-in and the other for zoom-out—might result in progressively zooming either in or out, with the button release returning the zoom level to the original value or to 100% (possibly with a further tandem action to determine which view is restored, for example).

In another embodiment relating to the ‘copy and paste function (and/or cut and paste)’ as described above, the default action would be set for a button press as ‘copy’ and an alternate action when the mouse is clicked (anywhere on screen) in tandem with the button press would prompt a ‘cut’ operation. Other such variants and/or extensions of functionality are possible in other embodiments.

It is noted that these non-menu actions use the press and lift of the buttons of device 10 for functions other than displaying and clearing menus or executing single discrete commands (that is, set to auto-execute in such a menu). These features would otherwise require, either: a specialised interface application capable of providing the given functionality; or else the Menu Manager application software to include the functionality (or functionalities) along with a means for the user to switch between the ‘menu’ mode and one or more of the other possible modes (for example, by clicking a link, or executing some appropriate series of actions).

In other embodiments, more radical departures from these preferred embodiments include the buttons of device 10 (with a suitable interface application or other software) being used to control devices and components such as DVD players, TVs, security, lighting amongst others, or in a translation device or other such devices where portability is an asset for applications outside of a standard desktop computer environment.

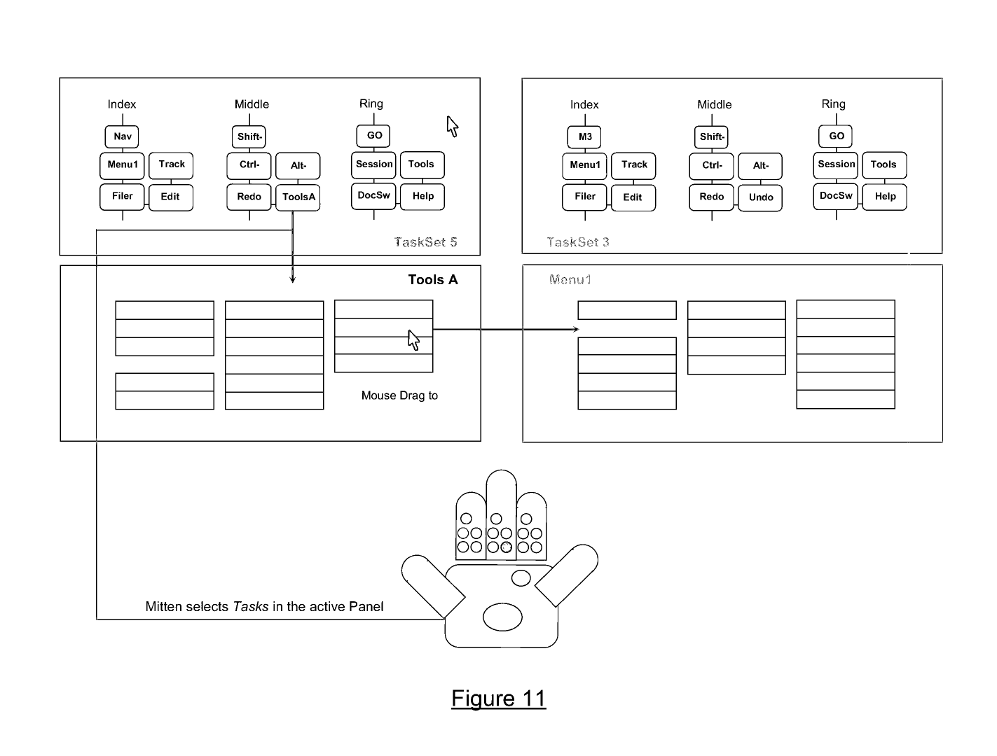

FIG. 10 shows how tasks are reassigned in the current set using panels. Mouse 12 moves its pointer over the ‘buttons’ in the upper panel to cause their content to appear (in this case for button 31) and be viewed in the lower panel, and then selects the task to be locked in for another button (in this case button 38) by clicking the pointer of mouse 12 on the selected task. This task is then assigned by pressing and lifting button 38. The assignment can be aborted, for example, by clicking the mouse anywhere on screen prior to lifting the pressed button.

FIG. 11 shows how sets and menus are assembled from the current ensemble using multiple task assignment maps panels. Several operations at either the set or task level are possible. Items can be dragged between the lower panels, or the upper panels clicked to enable device 10 to select tasks in either one. The displayed sets need not be ‘currently’ on device 10. Device 10 could be switched to one of the panels, or assigned one of the displayed sets, for example.

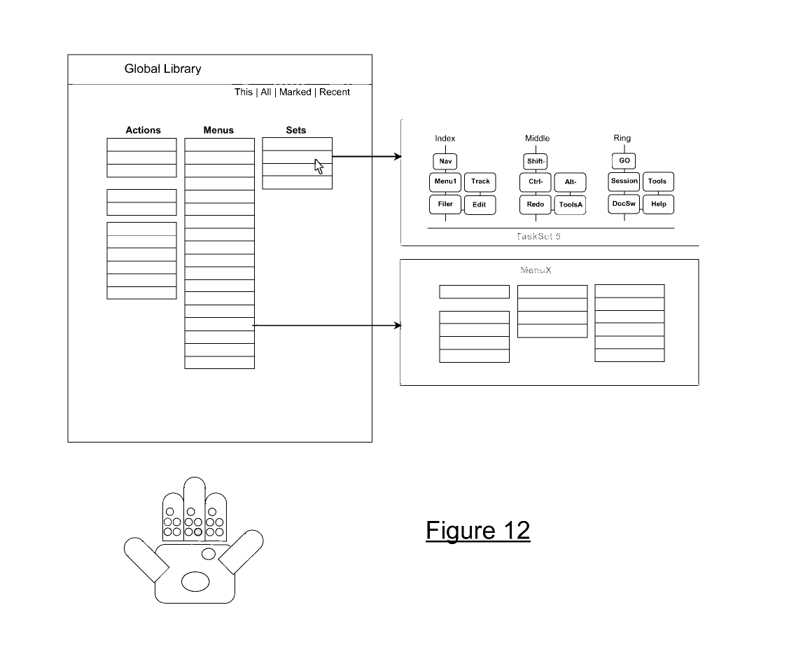

FIG. 12 shows the global library that appears when button 45 is tapped. This simplified view of the global library lists previously stored elements, copied or pasted from active or current elements, other applications, or the database. The content of the library is common across the session, enabling elements to be flexibly sourced across different applications. List items (such as sets and menus) can be ‘opened’ in a panel and viewed, assembled, and assigned. These operations follow the same general conventions as those described for other panels.

Other features of the software include look-up tables which are a register of standard or common commands and the keystrokes usually required to execute them (such as Ctrl-S for Save File), and preset configurations of potentially useful menu-items, menus, sets and ensembles, amongst others. The initial database (of actions, menus, sets and ensembles) for various commercial/freeware applications (such as MS Word, for use in default and/or user assembled menus), as well as various preset updates would be offered for newer applications (or versions), or developer sets for special applications.

Mitten applications (referred to M-APPs) are any user program specifically compatible with the actions of device 10, the Mitten. The menu manager described above is an M-APP and, for example, a given menu task can also run another M-APP.

FIGS. 7 and 8 are examples of a ‘self contained’ M-APP (that provides an overview of the user's session and allows switching). This type of utility would be provided by an operating system as a default.

In general, the range of Mitten Actions described herein are constrained by the form of device 10 and its button controls, but the functions these actions control (such as displaying items, executing commands) could be linked to other actions, devices and/or configurations of devices.

Modes of action other than use of device 10 for simply displaying menus can be envisaged for such an add-on (left hand) button device used with conventional applications. Examples of other button functions include:
Interface Control, for example, direct control of screen view selection, zooming, scrolling, navigating application spaces and fields, controlling window placement, splits, tiling, stacking order, appearance, amongst others.
Enhanced Clipboard, for elaborate capturing and control of screen, disk, or on-line information such as text, graphics, sound, emails, web or streamed content, for replaying, pasting, resending, or saving. This includes content specifically intended for device 10, as additional, supporting, updated, or privileged content. Buttons could be designated for various purposes, sources or content types, and content could be moved, merged, appended, edited, for example.

An example of another type of action is a Tool Selector/Modifier, where instead of assigning tools ‘per button’ (that is, button 39 is assigned to function of Tool A, button 31 is assigned Tool B, etc.), the tandem approach offers more methods of selection such as:
Toggle-Tool A or B, where a button press alternates between two tools or complementary options.
Switch-Tool B, where a button hold substitutes the current tool with a preselected tool and where the button lift to restores to the prior tool.
Modify-Tool A, where a button hold changes a tool parameter value (for example, the colour or size of text). The same button could modify different tools in different ways.
Selections can also be relative or defined on the fly, for example, selecting a previous tool, or a first tool in a sequence, complementary tool, a ‘tagged’ tool (that was tagged earlier by pressing the PALM button while in use).
Assigning a current tool to a certain button (say button 38) by pressing button 38 while the tool is in use (or tag as above and assign later).
Clicking a button of mouse 12 to select and use a currently held button's tool (that is the tool is not activated until mouse starts to use it).

These examples illustrate how the buttons of device 10 can be employed to match a user's more modulated needs.

Finally, the button-based platform could be augmented or replaced with other types of controller hardware.

These systems are not necessarily superior but are suited to particular applications; buttons have the advantage of reliability and versatility, and are suitable for a left-hand device where fine motor control may be lacking.

### CONCLUSIONS AND INTERPRETATION

Systems and methods described herein involve a device-based solution that runs its own user application as an interface. This software component is key to its functional independence and system-wide compatibility or universality, and amounts to a ‘virtual’ mini-OS running atop the user's regular (‘Windows-based’) session.

Each element (that is, the hardware and software) constitutes an extension to the system—one being a physical or ergonomic extension, the other, functional and operational. Together they constitute the required ‘device universality’ that serves to make this specific solution fundamentally significant (that is, operational across a typical standard session). Furthermore, the systems and methods described herein provide a model for a more general development path that is not restricted by the various ‘pragmatic’ considerations mentioned earlier.

The Mitten's implementation enables it to affect applications that do not directly support it, by interposing a software layer to mediate between the user's actions (ie. the device's direct events) and the target applications (which are presented with instructions and commands in a compatible form).

Specifically, the interposed software responds exclusively to the device (which it directly supports, along with the user's ‘standard’ devices and any others), and provides whatever interaction necessary, (including on-screen elements etc like any other application, in the process of displaying, selecting, editing and executing commands destined for the ‘target application’, which it then sends via the OS in some recognised or compatible form, e.g. either as standard user events (mouse-clicks, keystrokes etc) or command-line instructions etc.

The software does not merely translate the device events themselves, but simply amounts to a compartmentalised environment in which the user performs various actions (most of which are not directly output). Any commands destined for other applications are then generated by the software and sent on accordingly; they are not ‘Mitten events’ in another form, but coherent instructions triggered by the user's actions overall.

The systems and methods described herein offer a device that is supported by its own software application, which in turn also supports the other existing applications, in the sense that it must integrate in such a way that it contains sufficient information to send the right events, for the correct functions to be triggered, in each case. This information is obtained either (or in part) by direct interrogation, or from an explicit set of look-up tables' that contain the core command sets or, in other embodiments, just exceptions to the standard defaults, and to which additional commands could be appended or upgraded, and eventually maintained by application developers themselves.

In addition to this (two-ended) support, the underlying processes of the application 20 also integrates the switching of focus between the functional ‘interface’, with its displays and user interactivity, and the other target applications 101 (the user's normal environment, or ‘session’). Software 21 as a whole is therefore more than just an application and behaves more like a mini-operating system with ‘persistent’ elements (running continuously in the background) and, in embodiments, maintaining a log or history buffer of events across the system.

These two broadly independent aspects—that is the persistent, system or session elements that provide the universality and integration, and the specific functions and operation of the user application/interface portion—lead to the notion of a separate generalised module that could flexibly apply the same implementation scheme to any (one or more) attached interfaces and interface related applications (described above).

It will be appreciated that the disclosure above provides various significant systems and methods for implementing a user-actuated controller device for use with a standard computer operating system having a plurality of pre-existing applications.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present disclosure may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present disclosure may take the form of a method, an entirely hardware embodiment, an entirely software embodiment or an embodiment combining software and hardware aspects. Furthermore, the present disclosure may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present disclosure. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or OS.

It should be appreciated that in the above description of exemplary embodiments of the disclosure, various features of the disclosure are sometimes grouped together in a single embodiment, Figure, or description thereof for the purpose of streamlining the disclosure and aiding in the understanding of one or more of the various inventive aspects.

This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the disclosure.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the disclosure, those skilled in the art will recognize that other and further modifications may be made thereto without departing from the spirit of the disclosure, and it is intended to claim all such changes and modifications as falling within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

1. A control system for controlling one or more pre-existing user applications running on a standard computer system, the control system including:
at least one user interface; and
computer-system-level supplementary software for integrating with the one or more pre-existing user applications to enable the at least one user interface to at least partially control the one or more pre-existing user applications.

2. A control system according to claim 1 wherein the at least one user interface includes an intermediary interface application integratable with the one or more pre-existing user applications for providing a customizable set of uniquely executable user operations.

3. A control system according to claim 1 wherein the at least one user interface includes at least one on-screen visual display element viewable by a user.

4. A control system according to claim 1 wherein the at least one user interface includes a user control device configured to be used by a user's non-dominant hand such that the user control device is operable simultaneously and in conjunction with one or more existing controller devices.

5. A control system according to claim 4 wherein the user control device is a glove.

6-10. (canceled)

11. A computing device including:
at least one port for receiving user commands from at least two user interfaces, wherein one of the user interfaces is, in use, a hand mounted interface;
memory for storing primary software and supplementary software, wherein the supplementary software is associated with the hand mounted interface;
a processor that is responsive to:
(a) the primary software and the supplementary software for allowing the two user interfaces to contemporaneously operate; and
(b) the supplementary software for changing to the primary software to facilitate the contemporaneous operation.

12. A computing device according to claim 11 wherein the hand mounted interface includes at least two pressure sensors located on the hand mounted interface, and wherein the sensors are opposable to the tip of at least one digit.

13. A computing device according to claim 12 wherein the supplementary software provides at least one customizable command menu to be used with the primary software thereby extending the operational and functional capabilities of the pre-existing personal computer.

14-27. (canceled)

28. A method for carrying out a desired operation on a standard computer operating system using a first control device and a second control device, the method including:
carrying out a first predefined action with the first control device that both executes a first command and establishes a predefined recognised first state for the operating system, wherein the first state provides a first set of subsequent predefined commands;
based on the first set of subsequent predefined commands of the predefined recognised first state, carrying out a second predefined action with the second control device that both executes a second command from the set of subsequent predefined commands and establishes a desired recognised second state for the operating system, wherein the second state provides a second set of subsequent predefined commands; and
based on the second set of subsequent predefined commands of the desired recognised second state, carrying out a third predefined action with the second control device thereby carrying out the desired operation, wherein the devices are usable simultaneously and in conjunction.

29. A method according to claim 28 including a target application configured for use on the standard computer operating system wherein the desired operation executes a command on the target application.

30. A method according to claim 28 wherein the first control device includes at least one depressible button resiliently biased into a non-depressed position, and the first predefined action includes depressing the button.

31. A method according to claim 30 wherein the predefined recognised first state is maintained by holding the button in the depressed position.

32. A method according to claim 31 wherein the third predefined action includes releasing the button allowing the button to return to the non-depressed position.

33. A method according to claim 28 wherein the first control device includes at least one depressible button resiliently biased into a non-depressed position, and the first predefined action includes depressing and releasing the button.

34. A method according to claim 28 wherein the first control device includes a pointing device having a cursor, and the first predefined action includes positioning the cursor in a predefined location.

35. A method according to claim 34 wherein the pointing device is a computer mouse.

36. A method according to claim 28 wherein the second control device includes at least one depressible button resiliently biased into a non-depressed position, and the second predefined action includes depressing the button.

37. A method according to claim 36 where the predefined recognised second state is maintained by holding the button in the depressed position.

38. A method according to claim 37 where the third predefined action includes releasing the button allowing the button to return to the non-depressed position.

39. (canceled)
